(19) United States
(12) Patent Application Publication
(10) Pub. No.: US 2024/0354429 A1
(43) Pub. Date: Oct. 24, 2024

(54) COMMUNICATION METHOD INTEGRATED WITH TRUSTWORTHINESS MEASUREMENT

(71) Applicant: HUAWEI TECHNOLOGIES CO., LTD., Shenzhen (CN)

(72) Inventors: Yurong SONG, Shenzhen (CN); Fei LIU, Singapore (SG); Liqun CHEN, Surrey (GB); Donghui WANG, Beijing (CN); Christopher J.P. NEWTON, Surrey (GB); Loganathan PARTHIPAN, Surrey (GB); Yunpeng LI, Surrey (GB)

(73) Assignee: HUAWEI TECHNOLOGIES CO., LTD., Shenzhen, GD (CN)

(21) Appl. No.: 18/763,465

(22) Filed: Jul. 3, 2024

Related U.S. Application Data
(63) Continuation of application No. PCT/CN2022/137536, filed on Dec. 8, 2022.

(30) Foreign Application Priority Data
Jan. 5, 2022 (CN) 202210010007.6

(51) Int. Cl. G06F 21/60

(52) U.S. Cl. CPC G06F 21/606

(57) ABSTRACT

A method includes: a network function service consumer sends a service request message, where the service request message is used to request to obtain a service provided by a network function service provider. The network function service consumer receives a service response message, where the service response message indicates whether the service request message is accepted, and further indicates a result of trustworthiness verification of the network function service consumer. The method helps the network function service provider verify, before providing the network service, an identity of the network function service consumer and determine whether the network function service consumer is trusted, to help improve security of communication between core network elements and improve security of a core network device.

### CROSS-REFERENCE TO RELATED APPLICATIONS

This application is a continuation of International Application No. PCT/CN2022/137536, filed on Dec. 8, 2022, which claims priority to Chinese Patent Application No. 202210010007.6, filed on Jan. 5, 2022. The disclosures of the aforementioned applications are hereby incorporated by reference in their entireties.

### TECHNICAL FIELD

The embodiments relate to the communication field and to a communication method integrated with trustworthiness measurement and an apparatus.

### BACKGROUND

The 3rd generation partnership project (3GPP) sets no dedicated protection measure for security of core network elements, and sets no security measure for signaling exchange between the network elements. Therefore, insecure behavior of the network elements may cause great security risks such as hijacking the network elements by attackers and forging the core network elements.

A hijacked network element or a forged network element may further affect, as a malicious network element, a normal and trusted core network element. This causes problems such as a waste of resources and leakage of network element information data and user privacy data.

Therefore, it is necessary to set security measures for the security of the core network elements and the signaling exchange between the network elements to enhance protection of the network element information data and the user privacy data.

### SUMMARY

The embodiments include a communication method integrated with trustworthiness measurement to improve security of a core network element.

According to a first aspect, a communication method integrated with trustworthiness measurement is provided. The method may be performed by a first network element, or may be performed by a chip or a circuit used in the first network element. This is not limited. For case of description, an example in which the method is performed by the first network element is used below for description.

The method includes:

The first network element sends a registration request message, where the registration request message is used to request to register the first network element.

The first network element receives a registration response message, where the registration response message is used to respond to the registration request message, and further indicates a verification result of a first certificate, and the first certificate is for verifying whether a first trusted platform of the first network element is trusted.

In a possible implementation, the registration request message includes trusted-platform identification information of the first network element.

In a possible implementation, the trusted-platform identification information of the first network element is configured on a network repository network element before the first network element sends the registration request message.

According to the solution provided in this embodiment, the first network element sends the registration request message, so that the network repository network element obtains a registration request of the first network element. The first network element receives the registration response message, so that the first network element can obtain a result of the registration request. The registration response message indicates the verification result of the trusted certificate of the first network element, so that the first network element can determine whether the trusted platform of the first network element is trusted by the network repository network element. Implementation of the solution helps the network repository network element verify whether the trusted platform of the first network element is trusted. The trusted platform of the first network element is first verified before the first network element applies for an access token. This facilitates security of a subsequent token disclosure procedure and service request procedure, and helps improve security of the network repository network element, a network function service provider, and the like and improve security of a network communication process.

With reference to the first aspect, in some implementations of the first aspect, the request for registering the first network element succeeds, the registration response message includes a first trusted certificate, and the first trusted certificate is for attesting that the first trusted platform is trusted.

According to the solution provided in this embodiment, after the registration request of the first network element succeeds, the registration response message includes the first trusted certificate of the first network element, to attest that the trusted platform of the first network element is successfully verified by the network repository network element. The first trusted certificate may be used as proof of identification of the first network element in a subsequent communication process, for example, an access token obtaining procedure or the service request procedure, to attest that the first network element has a trusted platform that is trusted. This helps improve the security of the network repository network element and the network function service provider, and helps improve the security of the communication process between core network elements.

With reference to the first aspect, in some implementations of the first aspect, the request for registering the first network element fails, and the registration response message indicates that the first certificate fails to be verified.

According to the solution provided in this embodiment, after the registration request of the first network element fails, the registration response message includes an indication indicating that the first trusted certificate fails to be verified, and the first network element may obtain the indication after receiving the registration response message. This is beneficial to a next registration request procedure for the first network element to some extent, helps reduce unnecessary overheads of network resources of a core network, and helps improve quality of service of the core network element to the network function service consumer in a service process.

With reference to the first aspect, in some implementations of the first aspect, the first network element includes a second trusted platform. The first network element sends a re-registration request message, where the re-registration request message is used to request to register the first network element, and includes a second certificate, and the second certificate is for verifying whether the second trusted platform of the first network element is trusted.

According to the solution provided in this embodiment, the first certificate included in the registration request by the first network element fails to be verified. Because a failure cause that is of the registration request of the first network element and that is provided in the registration response message is that the first certificate of the first trusted platform fails to be verified, after obtaining the registration response message, the first network element may re-collect a certificate of another trusted platform for initiating a next registration request. Implementation of the solution helps improve efficiency of registering the first network element with the network repository network element, helps register the first network element with the network repository network element through a trusted platform that is trusted and authentic, and helps improve security of the core network element and the security of the communication process between the network elements.

With reference to the first aspect, in some implementations of the first aspect, the registration request message includes platform identification information, and the platform identification information identifies the trusted platform of the first network element.

According to the solution provided in this embodiment, the registration request message of the first network element includes the identification information indicating the trusted platform of the first network element, so that the network repository network element can obtain the identification information after receiving the registration request message, to determine, based on the identification information, the trusted platform supported by the first network element, and make a response for the platform. This helps the first network element obtain a network service as early as possible, and helps improve registration and authentication efficiency of the network repository network element for another network element.

According to a second aspect, a communication method integrated with trustworthiness measurement is provided. The method may be performed by a network function service consumer, or may be performed by a chip or a circuit used in the network function service consumer. This is not limited. For ease of description, an example in which the method is performed by the network function service consumer is used below for description.

The method includes:

The network function service consumer sends an authorization grant message, where the authorization grant message is used to request to obtain an access token, the access token includes information about a service that the network function service consumer is authorized to access, the authorization grant message includes a second trusted certificate, and the second trusted certificate is for verifying whether a trusted platform of the network function service consumer is trusted.

The network function service consumer receives an authorization response message, where the authorization response message indicates a result of the request for obtaining the access token.

In the solution provided in this embodiment, the network function service consumer sends the authorization grant message, so that a network repository network element obtains the request for applying for the access token by the network function service consumer. The authorization grant message includes the second trusted certificate, so that the network repository network element verifies whether the trusted platform of the network function service consumer is trusted. The network function service consumer may learn, by receiving the authorization response message, whether the request of the network function service consumer for applying for the access token is accepted. The solution is beneficial to efficiency of obtaining the access token by the network function service consumer, helps improve security of the network repository network element and a network function service provider, and helps improve security of a communication process between core network elements.

With reference to the second aspect, in some implementations of the second aspect, the network function service consumer receives first attestation identity information, where the first attestation identity information requests to obtain first attestation information or a second attestation result, the first attestation information is for verifying whether the network function service consumer is trusted, and the second attestation result includes an attestation result indicating that the network function service consumer has been attested to be trusted.

In a possible implementation, the second attestation result includes one or more of identity information, trusted content, and freshness, where the identity information indicates an identity of a verifier attesting that the network function service consumer is trusted, the trusted content indicates content that is of the network function service consumer and that is attested to be trusted, and the freshness indicates a time period in which the network function service consumer is attested to be trusted.

After receiving the first attestation identity information, the network function service consumer may prepare the first attestation information or the second attestation result that are to be used by the network repository network element to verify whether the network function service consumer is trusted. This helps improve the security of the communication between the core network elements and security of devices included in the core network function service consumer and a core network function service provider.

With reference to the second aspect, in some implementations of the second aspect, the authorization response message indicates that the access token is obtained, the access token includes a first attestation result, and the first attestation result includes an attestation result indicating that the network function service consumer is attested by the network repository network element to be trusted.

In the solution provided in this embodiment, the network function service consumer is authorized by the network repository network element, and the authorization response message includes the first attestation result. The first attestation result may include related information of current trustworthiness verification performed on the network function service consumer, and may be used by another verifier to perform trustworthiness verification on the network function service consumer next time. Implementation of the solution helps accelerate a rate of registering and performing authorization on the network function service consumer, and helps improve network function service experience of the network function service consumer.

With reference to the second aspect, in some implementations of the second aspect, the first attestation result includes one or more of identity information, trusted content, and freshness, where the identity information indicates the network repository network element, the trusted content indicates content that is of the network function service consumer and that is attested by the network repository network element to be trusted, and the freshness indicates a time period in which the network function service consumer is attested by the network repository network element to be trusted.

The first attestation result includes the identity information of the verifier, the trusted content, and the freshness, so that when trustworthiness verification is performed on the network function service consumer next time, the verifier can directly determine, by using the first attestation result, whether the network function service consumer is trusted.

An identity of the verifier of trustworthiness attestation corresponding to the first attestation result may be determined by using the identity information of the verifier. Specific trusted content attested in the trustworthiness attestation process corresponding to the first attestation result and whether the specific trusted content is applicable to the current trustworthiness attestation may be determined by using the trusted content. A time period in which the trustworthiness attestation corresponding to the first attestation result is completed may be determined by using the freshness, to determine whether the trustworthiness attestation result is within a validity period, and determine whether trustworthiness attestation needs to be performed again.

The first attestation result includes the foregoing information. This helps improve efficiency of the trustworthiness attestation, helps improve the security of the communication between the core network elements, and helps improve security of a device included in the network element.

With reference to the second aspect, in some implementations of the second aspect, the authorization response message indicates that the access token is not obtained, and further indicates that the second trusted certificate fails to be verified or first attestation information fails to be verified, and the first attestation information is for verifying whether the network function service consumer is trusted.

In a possible implementation, the authorization response message indicates that the second trusted certificate fails to be verified. After receiving the authorization response message, the network function service consumer determines an authentication failure cause, and selects a trusted certificate of another trusted platform for a next authentication process.

For example, the network function service consumer includes a trusted platform module (TPM) and an Intel SGX trusted platform, and a second certificate is for verifying whether the TPM trusted platform is trusted. After the second certificate fails to be verified, the network function service consumer may re-initiate an authorization request through the Intel SGX trusted platform.

In a possible implementation, the authorization response message indicates that the second trusted certificate fails to be verified. After receiving the authorization response message, the network function service consumer determines an authentication failure cause, and selects another certificate issuance manner to obtain a trusted certificate.

For example, the second trusted certificate of the network function service consumer is issued by a PCA. After the second trusted certificate fails to be verified, the network function service consumer may choose to obtain a trusted certificate of a trusted platform in a DAA manner, and initiate a next authorization request by using the re-issued trusted certificate.

In a possible implementation, the authorization response message indicates that the first attestation information fails to be verified. After receiving the authorization response message, the network function service consumer determines an authentication failure cause, and may re-collect related information for trustworthiness attestation, to regenerate attestation information for a next authentication process.

With reference to the second aspect, in some implementations of the second aspect, the authorization grant message further includes first attestation information, the first attestation information is generated based on first challenge data, and is for verifying whether the network function service consumer is trusted, the first challenge data is any one of a timestamp, a first random number, a second random number, and a value of an agreed field, the first random number is a random number provided by a trusted third party, and the second random number is a random number generated for verifying whether the trusted platform of the network function service consumer is trusted.

The timestamp, the value of the agreed field, the first random number, the second random number, and the like are used as a random number for generating the attestation information, so that trustworthiness verification in multiple manners can be implemented. Two parties of the trustworthiness verification may select different manners based on an actual case to determine the challenge data, to complete the trustworthiness verification. This helps improve the security of the communication between the core network elements, and helps improve the security of the device included in the network element.

According to a third aspect, a communication method integrated with trustworthiness measurement is provided. The method may be performed by a network function service consumer, or may be performed by a chip or a circuit used in the network function service consumer. This is not limited. For ease of description, an example in which the method is performed by the network function service consumer is used below for description.

The method includes:

The network function service consumer sends a service request message, where the service request message is used to request to obtain a service provided by a network function service provider.

The network function service consumer receives a service response message, where the service response message indicates whether the request for obtaining the service is accepted, and further indicates a result of trustworthiness verification of the network function service consumer.

In a possible implementation, the service response message indicates that the trustworthiness verification of the network function service consumer succeeds, and the network function service consumer may further request to verify whether the network function service provider is trusted.

In a possible implementation, the service response message indicates that the trustworthiness verification of the network function service consumer fails, and the network function service consumer may obtain a specific failure cause of the trustworthiness verification based on other content in the service response message, and re-prepares service request information based on the failure cause, to initiate a next service request.

According to the solution provided in this embodiment, after sending the service request message, the network function service consumer may receive the service response message. The service response message may indicate the result of the trustworthiness verification of the network function service consumer. The network function service consumer may make a response based on the verification result.

With reference to the third aspect, in some implementations of the third aspect, the network function service consumer receives second attestation identity information, where the second attestation identity information requests to obtain second attestation information or a third attestation result, the second attestation information is for verifying whether the network function service consumer is trusted, and the third attestation result includes an attestation result indicating that the network function service consumer has been attested to be trusted.

In a possible implementation, the third attestation result includes one or more of identity information, trusted content, and freshness, where the identity information indicates an identity of a verifier attesting that the network function service consumer is trusted, the trusted content indicates content that is of the network function service consumer and that is attested to be trusted, and the freshness indicates a time period in which the network function service consumer is attested to be trusted.

After receiving the attestation identity information, the network function service consumer may prepare the second attestation information or the third attestation result that are to be used by the network function service provider to verify whether the network function service consumer is trusted. This helps improve security of communication between core network elements and security of devices included in the core network function service consumer and provider.

With reference to the third aspect, in some implementations of the third aspect, the service response message indicates that the request for obtaining the service is accepted, the trustworthiness verification includes verification of a second attestation information or verification of a third attestation result, the second attestation information is for verifying whether the network function service consumer is trusted, and the third attestation result includes an attestation result indicating that the network function service consumer has been attested to be trusted.

In the solution provided in this embodiment, the second attestation information or the third attestation result of the network function service consumer is successfully verified, the second attestation information or the third attestation result is for attesting that the network function service consumer is in a trusted execution state, and the service request of the network function service consumer is accepted. The network service is provided to the network function service consumer after the network function service consumer is attested to be in the trusted execution state. This helps improve security of communication between core network elements and security of devices included in the core network function service consumer and provider.

With reference to the third aspect, in some implementations of the third aspect, the trustworthiness verification further includes verification of a first attestation result, and the first attestation result includes an attestation result indicating that the network function service consumer is attested by a network repository network element to be trusted.

In a possible implementation, the second attestation information or the third attestation result of the network function service consumer is first verified, and then the first attestation result is verified. The first attestation result is verified after the second attestation information or the third attestation result is successfully verified.

In a possible implementation, the first attestation result of the network function service consumer is first verified, and then the second attestation information or the third attestation result is verified. The second attestation information or the third attestation result is verified when the first attestation result fails to be verified.

In a possible implementation, both the second attestation information or the third attestation result and the first attestation result of the network function service consumer are successfully verified, and the network function service consumer obtains a network service with complete permission.

In a possible implementation, the second attestation information or the third attestation result of the network function service consumer is successfully verified, the first attestation result fails to be verified, and the network function service consumer obtains a network service with restricted permission.

In the solution provided in this embodiment, the verification of the second attestation information or the third attestation result and the verification of the first attestation result are set in the trustworthiness verification. This can implement double verification of the network function service consumer, and provide the service to the network function service consumer based on a verification status, to help improve the security of the communication between the core network elements and the security of the devices included in the core network function service consumer and provider.

With reference to the third aspect, in some implementations of the third aspect, the trustworthiness verification further includes verification of a third trusted certificate, and the verification of the third trusted certificate is performed to verify whether a trusted platform of the network function service consumer is trusted.

In a possible implementation, the trusted platform of the network function service consumer does not need to generate a trusted certificate in a trustworthiness attestation process, and the network function service provider does not verify the trusted certificate in a process of requesting the service by the network function service consumer.

In a possible implementation, the network function service provider first verifies the third trusted certificate, and obtains the attestation information or the attestation result of the network function service consumer after verifying that the third trusted certificate is correct, to perform further verification.

In the solution provided in this embodiment, the network function service provider may first verify the trusted certificate of the network function service consumer, and then perform other verification after determining that the trusted certificate is trusted. This helps improve verification efficiency of the network function service provider, accelerate obtaining of the network service by the network function service consumer, and improve network function service use experience of the network function service consumer.

With reference to the third aspect, in some implementations of the third aspect, the service response message indicates that the service request is accepted, the trustworthiness verification is verification of a first attestation result, and the first attestation result includes an attestation result indicating that the network function service consumer is attested by a network repository network element to be trusted.

In the solution provided in this embodiment, the network function service consumer may directly obtain the result of verification performed by the network repository network element on the network function service consumer, such as the first attestation result. The network function service provider verifies only the first attestation result, and does not verify attestation information or the like of the network function service consumer after the first attestation result is successfully verified. This simplifies a procedure for the trustworthiness verification, and helps improve efficiency of performing trustworthiness verification by the network function service provider, accelerate obtaining of the network function service by the network function service consumer, and improve security of communication between core network elements and security of devices included in the core network function service consumer and provider.

With reference to the third aspect, in some implementations of the third aspect, the service response message indicates that the service request is rejected, and indicates that a third trusted certificate fails to be verified, second attestation information fails to be verified, a first attestation result fails to be verified, or a third attestation result fails to be verified. The third trusted certificate is for verifying whether a trusted platform of the network function service consumer is trusted, the second attestation information is for verifying whether the network function service consumer is trusted, the first attestation result includes an attestation result indicating that the network function service consumer is attested by a network repository network element to be trusted, and the third attestation result includes an attestation result indicating that the network function service consumer has been attested to be trusted.

In a possible implementation, the service response message indicates that the third trusted certificate fails to be verified, and the network function service consumer determines a failure cause after receiving the service response message, and selects a trusted certificate of another trusted platform for a next service request.

For example, the network function service consumer includes a trusted platform module (TPM) and an Intel SGX trusted platform, and the third trusted certificate is for verifying whether the TPM is trusted. After the third trusted certificate fails to be verified, the network function service consumer may re-initiate a service request by using a trusted certificate of the Intel SGX trusted platform.

In a possible implementation, the service response message indicates that the third trusted certificate fails to be verified. After receiving the service response message, the network function service consumer determines a failure cause, and selects another certificate issuance manner to obtain a trusted certificate.

For example, the third trusted certificate of the network function service consumer is issued by a PCA. After the third trusted certificate fails to be verified, the network function service consumer may choose to obtain a trusted certificate of a trusted platform in a DAA manner, and use the re-issued trusted certificate for a next service request.

In a possible implementation, the service response message indicates that the second attestation information fails to be verified. After receiving the service response message, the network function service consumer determines a failure cause, and re-collects related information of a trusted platform corresponding to the second attestation information for trustworthiness attestation, to regenerate new attestation information for a next service request.

In a possible implementation, the service response message indicates that the second attestation information fails to be verified. After receiving the service response message, the network function service consumer determines a failure cause, and collects attestation information of another trusted platform for a next service request.

In a possible implementation, the service response message indicates that the second attestation information fails to be verified. After receiving the service response message, the network function service consumer determines a failure cause, and prepares an attestation result of another trusted platform for a next service request.

In a possible implementation, the service response message indicates that the third attestation result fails to be verified. After receiving the authorization response message, the network function service consumer determines an authentication failure cause, and re-collects related information of a trusted platform corresponding to the third attestation result for trustworthiness attestation, to regenerate new attestation information for a next service request.

In a possible implementation, the service response message indicates that the third attestation result fails to be verified. After receiving the authorization response message, the network function service consumer determines an authentication failure cause, and prepares an attestation result of another trusted platform for a next service request.

In a possible implementation, the service response message indicates that the third attestation result fails to be verified. After receiving the authorization response message, the network function service consumer determines an authentication failure cause, and prepares attestation information of another trusted platform for a next service request.

The service response message includes the failure cause of the trustworthiness verification, so that the network function service consumer may determine the failure cause by using the service response message, to make a targeted response to better prepare for the next service request.

With reference to the third aspect, in some implementations of the third aspect, the service request message further includes second attestation information, the second attestation information is generated based on second challenge data, and is for verifying whether the network function service consumer is trusted, the second challenge data is any one of a timestamp, a first random number, a second random number, and a value of an agreed field, the first random number is a random number provided by a trusted third party, and the second random number is a random number generated for verifying whether the trusted platform of the network function service consumer is trusted.

The timestamp, the value of the agreed field, the first random number, the second random number, and the like are used as a random number for generating the attestation information, so that trustworthiness verification in multiple manners can be implemented. Two parties of the trustworthiness verification may select different manners based on an actual case to determine the challenge data, to complete the trustworthiness verification. This helps improve the security of the communication between the core network elements, and helps improve security of a device included in a network element.

According to a fourth aspect, a communication method integrated with trustworthiness measurement is provided. The method may be performed by a network repository network element, or may be performed by a chip or a circuit used in the network repository network element. This is not limited. For ease of description, an example in which the method is performed by the network repository network element is used below for description.

The method includes:

The network repository network element receives a registration request message, where the registration request message is used to request to register a first network element.

The network repository network element sends a registration response message, where the registration response message is used to respond to the registration request message, and further indicates a verification result of a first certificate, and the first certificate is for verifying whether a first trusted platform of the first network element is trusted.

In a possible implementation, the registration request message includes trusted-platform identification information of the first network element.

In a possible implementation, the trusted-platform identification information of the first network element is configured on the network repository network element before the first network element sends the registration request message.

According to the solution provided in this embodiment, the first network element sends the registration request message, so that the network repository network element obtains a registration request of the first network element. The first network element receives the registration response message, so that the first network element can obtain a result of the registration request. The registration response message indicates a verification result of a trusted certificate of the first network element, so that the first network element can determine whether the trusted platform of the first network element is trusted by the network repository network element. Implementation of the solution helps the network repository network element verify whether the trusted platform of the first network element is trusted. The trusted platform of the first network element is first verified before the first network element applies for an access token. This facilitates security of a subsequent token disclosure procedure and service request procedure, and helps improve security of the network repository network element, a network function service provider, and the like and improve security of a network communication process.

With reference to the fourth aspect, in some implementations of the fourth aspect, the request for registering the first network element succeeds, the registration response message includes a first trusted certificate, and the first trusted certificate is for attesting that the first trusted platform is trusted.

According to the solution provided in this embodiment, after the registration request of the first network element succeeds, the registration response message includes the first trusted certificate of the first network element, to attest that the trusted platform of the first network element is successfully verified by the network repository network element. The first trusted certificate may be used as proof of identification of the first network element in a subsequent communication process, for example, an access token obtaining procedure or the service request procedure, to attest that the first network element has a trusted platform that is trusted. This helps improve the security of the network repository network element and the network function service provider, and helps improve the security of the communication process between core network elements.

With reference to the fourth aspect, in some implementations of the fourth aspect, the request for registering the first network element fails, and the registration response message indicates that the first certificate fails to be verified.

According to the solution provided in this embodiment, after the registration request of the first network element fails, the registration response message includes an indication indicating that the first trusted certificate fails to be verified, and the first network element may obtain the indication after receiving the registration response message. This is beneficial to a next registration request procedure for the first network element to some extent, helps reduce unnecessary overheads of network resources of a core network, and helps improve quality of service of the core network element to the network function service consumer in a service process.

With reference to the fourth aspect, in some implementations of the fourth aspect, the first network element includes a second trusted platform, and the network repository network element receives a re-registration request message, where the re-registration request message is used to request to register the first network element, and includes a second certificate, and the second certificate is for verifying whether the second trusted platform of the first network element is trusted.

According to the solution provided in this embodiment, the first certificate included in the registration request by the first network element fails to be verified. Because a failure cause that is of the registration request of the first network element and that is provided in the registration response message is that the first certificate of the first trusted platform fails to be verified, after obtaining the registration response message, the first network element may re-collect a certificate of another trusted platform for initiating a next registration request. Implementation of the solution helps improve efficiency of registering the first network element with the network repository network element, helps register the first network element with the network repository network element through a trusted platform that is trusted and authentic, and helps improve security of the core network element and the security of the communication process between the network elements.

With reference to the fourth aspect, in some implementations of the fourth aspect, the registration request message includes platform identification information, and the platform identification information identifies the trusted platform of the first network element.

According to the solution provided in this embodiment, the registration request message of the first network element includes the identification information indicating the trusted platform of the first network element, so that the network repository network element can obtain the identification information after receiving the registration request message, to determine, based on the identification information, the trusted platform supported by the first network element, and make a response for the platform. This helps the first network element obtain a network service as early as possible, and helps improve registration and authentication efficiency of the network repository network element for another network element.

According to a fifth aspect, a communication method integrated with trustworthiness measurement is provided. The method may be performed by a network repository network element, or may be performed by a chip or a circuit used in the network repository network element. This is not limited. For ease of description, an example in which the method is performed by the network repository network element is used below for description.

The method includes:

The network repository network element receives an authorization grant message, where the authorization grant message is used to request to obtain an access token, the access token includes information about a service that a network function service consumer is authorized to access, the authorization grant message includes a second trusted certificate, and the second trusted certificate is for verifying whether a trusted platform of the network function service consumer is trusted.

The network repository network element sends an authorization response message, where the authorization response message indicates a result of the request for obtaining the access token.

In the solution provided in this embodiment, the network function service consumer sends the authorization grant message, so that the network repository network element obtains the request for applying for the access token by the network function service consumer. The authorization grant message includes the second trusted certificate, so that the network repository network element verifies whether the trusted platform of the network function service consumer is trusted. The network function service consumer may learn, by receiving the authorization response message, whether the request of the network function service consumer for applying for the access token is accepted. The solution is beneficial to efficiency of obtaining the access token by the network function service consumer, helps improve security of the network repository network element and a network function service provider, and helps improve security of a communication process between core network elements.

With reference to the fifth aspect, in some implementations of the fifth aspect, the network repository network element sends first attestation information, where the first attestation identity information requests to obtain first attestation identity information or a second attestation result, the first attestation information is for verifying whether the network function service consumer is trusted, and the second attestation result includes an attestation result indicating that the network function service consumer has been attested to be trusted.

After receiving the first attestation identity information, the network function service consumer may prepare the first attestation information or the second attestation result that are to be used by the network repository network element to verify whether the network function service consumer is trusted. This helps improve the security of the communication between the core network elements and security of devices included in the core network function service consumer and a core network function service provider.

With reference to the fifth aspect, in some implementations of the fifth aspect, the authorization response message indicates that the access token is obtained, the access token includes a first attestation result, and the first attestation result includes an attestation result indicating that the network function service consumer is attested by the network repository network element to be trusted.

In the solution provided in this embodiment, the network function service consumer is authorized by the network repository network element, and the authorization response message includes the first attestation result. The first attestation result may include related information of current trustworthiness verification performed on the network function service consumer, and may be used by another verifier to perform trustworthiness verification on the network function service consumer next time. Implementation of the solution helps accelerate a rate of registering and performing authorization on the network function service consumer, and helps improve network function service experience of the network function service consumer.

With reference to the fifth aspect, in some implementations of the fifth aspect, the first attestation result includes one or more of identity information, trusted content, and freshness, where the identity information indicates the network repository network element, the trusted content indicates content that is of the network function service consumer and that is attested by the network repository network element to be trusted, and the freshness indicates a time period in which the network function service consumer is attested by the network repository network element to be trusted.

The first attestation result includes the identity information of a verifier, the trusted content, and the freshness, so that when trustworthiness verification is performed on the network function service consumer next time, the verifier can directly determine, by using the first attestation result, whether the network function service consumer is trusted.

An identity of the verifier of trustworthiness attestation corresponding to the first attestation result may be determined by using the identity information of the verifier. Specific trusted content attested in the trustworthiness attestation process corresponding to the first attestation result and whether the specific trusted content is applicable to the current trustworthiness attestation may be determined by using the trusted content. A time period in which the trustworthiness attestation corresponding to the first attestation result is completed may be determined by using the freshness, to determine whether the trustworthiness attestation result is within a validity period, and determine whether trustworthiness attestation needs to be performed again.

The first attestation result includes the foregoing information. This helps improve efficiency of the trustworthiness attestation, helps improve the security of the communication between the core network elements, and helps improve security of a device included in the network element.

With reference to the fifth aspect, in some implementations of the fifth aspect, the authorization response message indicates that the access token is not obtained, and further indicates that the second trusted certificate or first attestation information fails to be verified, and the first attestation information is for verifying whether the network function service consumer is trusted.

In a possible implementation, the authorization response message indicates that the second trusted certificate fails to be verified. After receiving the authorization response message, the network function service consumer determines an authorization failure cause, and selects a trusted certificate of another trusted platform for a next authorization process.

For example, the network function service consumer includes a trusted platform module (TPM) and an Intel SGX trusted platform, and a second certificate is for verifying whether the TPM trusted platform is trusted. After the second certificate fails to be verified, the network function service consumer may re-initiate an authorization request through the Intel SGX trusted platform.

In a possible implementation, the authorization response message indicates that the second trusted certificate fails to be verified. After receiving the authorization response message, the network function service consumer determines an authorization failure cause, and selects another certificate issuance manner to obtain a trusted certificate.

For example, the second trusted certificate of the network function service consumer is issued by a PCA. After the second trusted certificate fails to be verified, the network function service consumer may choose to obtain a trusted certificate of a trusted platform in a DAA manner, and initiate a next authorization request by using the re-issued trusted certificate.

In a possible implementation, the authorization response message indicates that the first attestation information fails to be verified. After receiving the authorization response message, the network function service consumer determines an authorization failure cause, and may re-collect related information for trustworthiness attestation, to regenerate attestation information for a next authorization process.

With reference to the fifth aspect, in some implementations of the fifth aspect, the authorization grant message further includes first attestation information, the first attestation information is generated based on first challenge data, and is for verifying whether the network function service consumer is trusted, the first challenge data is any one of a timestamp, a first random number, a second random number, and a value of an agreed field, the first random number is a random number provided by a trusted third party, and the second random number is a random number generated for verifying whether the trusted platform of the network function service consumer is trusted.

In a possible implementation, the challenge data is the timestamp, and the timestamp is clock information trusted by both the network function service consumer and the network repository network element.

For example, the challenge data is clock information generated by the TPM trusted platform of the network function service consumer.

In a possible implementation, the challenge data is the value of the agreed field, and the agreed field may be determined according to an Internet protocol that both the network function service consumer and the network repository network element comply with.

For example, it is specified in the OAuth 2.0 protocol that bit data of the 128^{th} to 160^{th} bits of the authorization grant message is used as the challenge data, and both the network function service consumer and the network repository network element comply with the OAuth 2.0 protocol. In this case, the network function service consumer obtains the bit data of the 128^{th} to 160^{th} bits of the authorization grant message as the challenge data.

In a possible implementation, the challenge data is the first random number, the first random number is a random number trusted by both the network function service consumer and the network repository network element, and the first random number may be provided by the trusted third party.

For example, the first random number is generated by using a blockchain (for example, is a timestamp or a hash value of a latest block in the blockchain), and the network function service consumer uses the first random number as the challenge data after obtaining the first random number.

In a possible implementation, the challenge data is the second random number, and the second random number is a random number generated by the network function service provider to verify whether the network function service consumer is trusted.

The timestamp, the value of the agreed field, the first random number, the second random number, and the like are used as a random number for generating the attestation information, so that trustworthiness verification in multiple manners can be implemented. Two parties of the trustworthiness verification may select different manners based on an actual case to determine the challenge data, to complete the trustworthiness verification. This helps improve the security of the communication between the core network elements, and helps improve the security of the device included in the network element.

According to a sixth aspect, a communication method integrated with trustworthiness measurement is provided. The method may be performed by a network function service provider, or may be performed by a chip or a circuit used in the network function service provider. This is not limited. For ease of description, an example in which the method is performed by the network function service provider is used below for description.

The method includes:

The network function service provider receives a service request message, where the service request message is used to request to obtain a service provided by the network function service provider.

The network function service provider sends a service response message, where the service response message indicates whether the request for obtaining the service is accepted, and further indicates a result of trustworthiness verification of a network function service consumer.

In a possible implementation, the service response message indicates that the trustworthiness verification of the network function service consumer succeeds, and the network function service consumer may further request to verify whether the network function service provider is trusted.

In a possible implementation, the service response message indicates that the trustworthiness verification of the network function service consumer fails, and the network function service consumer may obtain a specific failure cause of the trustworthiness verification based on other content in the service response message, and re-prepares service request information based on the failure cause, to initiate a next service request.

According to the solution provided in this embodiment, after sending the service request message, the network function service consumer may receive the service response message. The service response message may indicate the result of the trustworthiness verification of the network function service consumer. The network function service consumer may make a response based on the verification result.

With reference to the sixth aspect, in some implementations of the sixth aspect, the network function service provider sends second attestation identity information, where the second attestation identity information requests to obtain second attestation information or a third attestation result, the second attestation information is for verifying whether the network function service consumer is trusted, and the third attestation result includes an attestation result indicating that the network function service consumer has been attested to be trusted.

After receiving the attestation identity information, the network function service consumer may prepare the second attestation information or the third attestation result that are to be used by the network function service provider to verify whether the network function service consumer is trusted. This helps improve security of communication between core network elements and security of devices included in the core network function service consumer and provider.

With reference to the sixth aspect, in some implementations of the sixth aspect, the service response message indicates that the request for obtaining the service is accepted, the trustworthiness verification includes verification of second attestation information or verification of a third attestation result, the second attestation information is for verifying whether the network function service consumer is trusted, and the third attestation result includes an attestation result indicating that the network function service consumer has been attested to be trusted.

In the solution provided in this embodiment, the second attestation information or the third attestation result of the network function service consumer is successfully verified, the second attestation information or the third attestation result is for attesting that the network function service consumer is in a trusted execution state, and the service request of the network function service consumer is accepted. The network service is provided to the network function service consumer after the network function service consumer is attested to be in the trusted execution state. This helps improve security of communication between core network elements and security of devices included in the core network function service consumer and provider.

With reference to the sixth aspect, in some implementations of the sixth aspect, the trustworthiness verification further includes verification of a first attestation result, and the first attestation result includes an attestation result indicating that the network function service consumer is attested by a network repository network element to be trusted.

In a possible implementation, the second attestation information or the third attestation result of the network function service consumer is first verified, and then the first attestation result is verified. The first attestation result is verified after the second attestation information or the third attestation result is successfully verified.

In a possible implementation, the first attestation result of the network function service consumer is first verified, and then the second attestation information or the third attestation result is verified. The second attestation information or the third attestation result is verified when the third attestation result fails to be verified.

In a possible implementation, both the second attestation information or the third attestation result and the first attestation result of the network function service consumer are successfully verified, and the network function service consumer obtains a network service with complete permission.

In a possible implementation, the second attestation information or the third attestation result of the network function service consumer is successfully verified, the first attestation result fails to be verified, and the network function service consumer obtains a network service with restricted permission.

In the solution provided in this embodiment, the verification of the second attestation information or the third attestation result and the verification of the first attestation result are set in the trustworthiness verification. This can implement double verification of the network function service consumer, and provide the service to the network function service consumer based on a verification status, to help improve the security of the communication between the core network elements and the security of the devices included in the core network function service consumer and provider.

With reference to the sixth aspect, in some implementations of the sixth aspect, the trustworthiness verification further includes verification of a third trusted certificate, and the verification of the third trusted certificate is performed to verify whether a trusted platform of the network function service consumer is trusted.

In a possible implementation, the trusted platform of the network function service consumer does not need to generate a trusted certificate in a trustworthiness attestation process, and the network function service provider does not verify the trusted certificate in a process of requesting the service by the network function service consumer.

In a possible implementation, the network function service provider first verifies the third trusted certificate, and obtains the attestation information or the attestation result of the network function service consumer after verifying that the third trusted certificate is correct, to perform further verification.

In the solution provided in this embodiment, the network function service provider may first verify the trusted certificate of the network function service consumer, and then perform other verification after determining that the trusted certificate is trusted. This helps improve verification efficiency of the network function service provider, accelerate obtaining of the network service by the network function service consumer, and improve network function service use experience of the network function service consumer.

With reference to the sixth aspect, in some implementations of the sixth aspect, the service response message indicates that the service request is accepted, the trustworthiness verification is verification of a first attestation result, and the first attestation result includes an attestation result indicating that the network function service consumer is attested by a network repository network element to be trusted.

In the solution provided in this embodiment, the network function service consumer may directly obtain the result of verification performed by the network repository network element on the network function service consumer, such as the first attestation result. The network function service provider verifies only the first attestation result, and does not verify attestation information or the like of the network function service consumer after the first attestation result is successfully verified. This simplifies a procedure for the trustworthiness verification, and helps improve efficiency of performing trustworthiness verification by the network function service provider, accelerate obtaining of the network function service by the network function service consumer, and improve security of communication between core network elements and security of devices included in the core network function service consumer and provider.

With reference to the sixth aspect, in some implementations of the sixth aspect, the service response message indicates that the service request is rejected, and indicates that a third trusted certificate fails to be verified, second attestation information fails to be verified, a first attestation result fails to be verified, or a third attestation result fails to be verified. The third trusted certificate is for verifying whether a trusted platform of the network function service consumer is trusted, the second attestation information is for verifying whether the network function service consumer is trusted, the first attestation result includes an attestation result indicating that the network function service consumer is attested by a network repository network element to be trusted, and the third attestation result includes an attestation result indicating that the network function service consumer is attested last time to be trusted.

In a possible implementation, the service response message indicates that the third trusted certificate fails to be verified, and the network function service consumer determines a failure cause after receiving the service response message, and selects a trusted certificate of another trusted platform for a next service request.

For example, the network function service consumer includes a trusted platform module (TPM) and an Intel SGX trusted platform, and the third trusted certificate is for verifying whether the TPM is trusted. After the third trusted certificate fails to be verified, the network function service consumer may re-initiate a service request by using a trusted certificate of the Intel SGX trusted platform.

In a possible implementation, the service response message indicates that the third trusted certificate fails to be verified. After receiving the service response message, the network function service consumer determines a failure cause, and selects another certificate issuance manner to obtain a trusted certificate.

For example, the third trusted certificate of the network function service consumer is issued by a PCA. After the third trusted certificate fails to be verified, the network function service consumer may choose to obtain a trusted certificate of a trusted platform in a DAA manner, and use the re-issued trusted certificate for a next service request.

In a possible implementation, the service response message indicates that the second attestation information fails to be verified. After receiving the service response message, the network function service consumer determines a failure cause, and re-collects related information of a trusted platform corresponding to the second attestation information for trustworthiness attestation, to regenerate new attestation information for a next service request.

In a possible implementation, the service response message indicates that the second attestation information fails to be verified. After receiving the service response message, the network function service consumer determines a failure cause, and collects attestation information of another trusted platform for a next service request.

In a possible implementation, the service response message indicates that the second attestation information fails to be verified. After receiving the service response message, the network function service consumer determines a failure cause, and prepares an attestation result of another trusted platform for a next service request.

In a possible implementation, the service response message indicates that the third attestation result fails to be verified. After receiving the authorization response message, the network function service consumer determines an authorization failure cause, and re-collects related information of a trusted platform corresponding to the third attestation result for trustworthiness attestation, to regenerate new attestation information for a next service request.

In a possible implementation, the service response message indicates that the third attestation result fails to be verified. After receiving the authorization response message, the network function service consumer determines an authorization failure cause, and prepares an attestation result of another trusted platform for a next service request.

In a possible implementation, the service response message indicates that the third attestation result fails to be verified. After receiving the authorization response message, the network function service consumer determines an authorization failure cause, and prepares attestation information of another trusted platform for a next service request.

The service response message includes the failure cause of the trustworthiness verification, so that the network function service consumer may determine the failure cause by using the service response message, to make a targeted response to better prepare for the next service request.

With reference to the sixth aspect, in some implementations of the sixth aspect, the service request message further includes second attestation information, the second attestation information is generated based on second challenge data, the second attestation information is for verifying whether the network function service consumer is trusted, and the second challenge data is any one of a timestamp, a first random number, a second random number, and a value of an agreed field.

For example, the challenge data is clock information generated by the TPM trusted platform of the network function service consumer.

In a possible implementation, the challenge data is the value of the agreed field, and the agreed field may be determined according to an Internet protocol that both the network function service consumer and the network function service provider comply with.

For example, it is specified in the OAuth 2.0 protocol that bit data of the 128^{th} to 160^{th} bits of the authorization grant message is used as the challenge data, and both the network function service consumer and the network repository network element comply with the OAuth 2.0 protocol. In this case, the network function service consumer obtains the bit data of the 128^{th} to 160^{th} bits of the authorization grant message as the challenge data.

In a possible implementation, the challenge data is the first random number, the first random number is a random number trusted by both the network function service consumer and the network function service provider, and the first random number may be provided by a trusted third party.

For example, the first random number is generated by using a blockchain (for example, is a timestamp or a hash value of a latest block in the blockchain), and the network function service consumer uses the first random number as the challenge data after obtaining the first random number.

The timestamp, the value of the agreed field, the first random number, the second random number, and the like are used as a random number for generating the attestation information, so that trustworthiness verification in multiple manners can be implemented. Two parties of the trustworthiness verification may select different manners based on an actual case to determine the challenge data, to complete the trustworthiness verification. This helps improve the security of the communication between the core network elements, and helps improve the security of the device included in the network element.

According to a seventh aspect, a communication apparatus is provided. The communication apparatus includes a sending module and a receiving module.

The sending module is configured to send a registration request message, where the registration request message is used to request to register a first network element.

The receiving module is configured to receive a registration response message, where the registration response message is used to respond to the registration request message, and further indicates a verification result of a first certificate, and the first certificate is for verifying whether a first trusted platform of the first network element is trusted.

With reference to the seventh aspect, in some implementations of the seventh aspect, the sending module is further configured to send a re-registration request message, where the re-registration request message includes a second certificate, and the second certificate is for verifying whether a second trusted platform of the first network element is trusted.

According to an eighth aspect, a communication apparatus is provided. The communication apparatus includes a sending module and a receiving module.

The sending module is configured to send an authorization grant message, where the authorization grant message is used to request to obtain an access token, the access token includes information about a service that a network function service consumer is authorized to access, the authorization grant message includes a second trusted certificate, and the second trusted certificate is for verifying whether a trusted platform of the network function service consumer is trusted.

The receiving module is configured to receive an authorization response message, where the authorization response message indicates a result of the request for obtaining the access token.

With reference to the eighth aspect, in some implementations of the eighth aspect, the receiving module is further configured to receive first attestation identity information, where the first attestation identity information requests to obtain first attestation information or a second attestation result, the first attestation information is for verifying whether the network function service consumer is trusted, and the second attestation result includes an attestation result indicating that the network function service consumer has been attested to be trusted.

According to a ninth aspect, a communication apparatus is provided. The communication apparatus includes a sending module and a receiving module.

The sending module is configured to send a service request message, where the service request message is used to request to obtain a service provided by a network function service provider.

The receiving module is configured to receive a service response message, where the service response message indicates whether the service request is accepted, and further indicates a result of trustworthiness verification of a network function service consumer.

With reference to the ninth aspect, in some implementations of the ninth aspect, the receiving module is further configured to receive second attestation identity information, where the second attestation identity information requests to obtain second attestation information or a third attestation result, the second attestation information is for verifying whether the network function service consumer is trusted, and the third attestation result includes an attestation result indicating that the network function service consumer has been attested to be trusted.

According to a tenth aspect, a communication apparatus is provided. The communication apparatus includes a receiving module and a sending module.

The receiving module is configured to receive a registration request message, where the registration request message is used to request to register a first network element.

The sending module is configured to send a registration response message, where the registration response message is used to respond to the registration request message, and further indicates a verification result of a first certificate, and the first certificate is for verifying whether a first trusted platform of the first network element is trusted.

With reference to the tenth aspect, in some implementations of the tenth aspect, the receiving module is further configured to receive a re-registration request message, where the re-registration request message includes a second certificate, and the second certificate is for verifying whether a second trusted platform of the first network element is trusted.

According to an eleventh aspect, a communication apparatus is provided. The communication apparatus includes a receiving module and a sending module.

The receiving module is configured to receive an authorization grant message, where the authorization grant message is used to request to obtain an access token, the access token includes information about a service that a network function service consumer is authorized to access, the authorization grant message includes a second trusted certificate, and the second trusted certificate is for verifying whether a trusted platform of the network function service consumer is trusted.

The sending module is configured to send an authorization response message, where the authorization response message indicates a result of the request for obtaining the access token.

With reference to the eleventh aspect, in some implementations of the eleventh aspect, the sending module is further configured to send first attestation identity information, where the first attestation identity information requests to obtain first attestation information or a second attestation result, the first attestation information is for verifying whether the network function service consumer is trusted, and the second attestation result includes an attestation result indicating that the network function service consumer has been attested to be trusted.

According to a twelfth aspect, a communication apparatus is provided. The communication apparatus includes a receiving module and a sending module.

The receiving module is configured to receive a service request message, where the service request message is used to request to obtain a service provided by a network function service provider.

The sending module is configured to send a service response message, where the service response message indicates whether the service request is accepted, and further indicates a result of trustworthiness verification of a network function service consumer.

With reference to the twelfth aspect, in some implementations of the twelfth aspect, the sending module is further configured to send second attestation identity information, where the second attestation identity information requests to obtain second attestation information or a third attestation result, the second attestation information is for verifying whether the network function service consumer is trusted, and the third attestation result includes an attestation result indicating that the network function service consumer has been attested to be trusted.

According to a thirteenth aspect, a communication device is provided, including at least one processor, where the at least one processor is coupled to at least one memory, the at least one memory is configured to store a computer program or instructions, and the at least one processor is configured to invoke the computer program or instructions from the at least one memory and run the computer program or instructions, so that the communication device performs the method according to any one of the first aspect or the possible implementations of the first aspect.

According to a fourteenth aspect, a communication device is provided, including at least one processor, where the at least one processor is coupled to at least one memory, the at least one memory is configured to store a computer program or instructions, and the at least one processor is configured to invoke the computer program or instructions from the at least one memory and run the computer program or instructions, so that the communication device performs the method according to any one of the second aspect, the third aspect, or the possible implementations of the second aspect and the third aspect.

According to a fifteenth aspect, a communication device is provided, including at least one processor, where the at least one processor is coupled to at least one memory, the at least one memory is configured to store a computer program or instructions, and the at least one processor is configured to invoke the computer program or instructions from the at least one memory and run the computer program or instructions, so that the communication device performs the method according to any one of the fourth aspect, the fifth aspect, or the possible implementations of the fourth aspect and the fifth aspect.

According to a sixteenth aspect, a communication device is provided, including at least one processor, where the at least one processor is coupled to at least one memory, the at least one memory is configured to store a computer program or instructions, and the at least one processor is configured to invoke the computer program or instructions from the at least one memory and run the computer program or instructions, so that the communication device performs the method according to any one of the sixth aspect or the possible implementations of the sixth aspect.

According to a seventeenth aspect, a non-transitory computer-readable storage medium is provided. The non-transitory computer-readable storage medium stores computer instructions; and when the computer instructions are run on a computer, the method according to any one of the first aspect or the possible implementations of the first aspect is performed.

According to an eighteenth aspect, a non-transitory computer-readable storage medium is provided. The non-transitory computer-readable storage medium stores computer instructions; and when the computer instructions are run on a computer, the method according to any one of the second aspect, the third aspect, or the possible implementations of the second aspect and the third aspect is performed.

According to a nineteenth aspect, a non-transitory computer-readable storage medium is provided. The non-transitory computer-readable storage medium stores computer instructions; and when the computer instructions are run on a computer, the method according to any one of the fourth aspect, the fifth aspect, or the possible implementations of the fourth aspect and the fifth aspect is performed.

According to a twentieth aspect, a non-transitory computer-readable storage medium is provided. The non-transitory computer-readable storage medium stores computer instructions; and when the computer instructions are run on a computer, the method according to any one of the sixth aspect or the possible implementations of the sixth aspect is performed.

According to a twenty-first aspect, a computer program product is provided. The computer program product includes computer program code; and when the computer program code is run on a computer, the method according to any one of the first aspect or the possible implementations of the first aspect is performed.

According to a twenty-second aspect, a computer program product is provided. The computer program product includes computer program code; and when the computer program code is run on a computer, the method according to any one of the second aspect, the third aspect, or the possible implementations of the second aspect and the third aspect is performed.

According to a twenty-third aspect, a computer program product is provided. The computer program product includes computer program code; and when the computer program code is run on a computer, the method according to any one of the fourth aspect, the fifth aspect, or the possible implementations of the fourth aspect and the fifth aspect is performed.

According to a twenty-fourth aspect, a computer program product is provided. The computer program product includes computer program code; and when the computer program code is run on a computer, the method according to any one of the sixth aspect or the possible implementations of the sixth aspect is performed.

According to a twenty-fifth aspect, a chip is provided, including a processor configured to read instructions stored in a memory. When the processor executes the instructions, the chip is enabled to implement the method according to any one of the first aspect or the possible implementations of the first aspect.

According to a twenty-sixth aspect, a chip is provided, including a processor configured to read instructions stored in a memory. When the processor executes the instructions, the chip is enabled to implement the method according to any one of the second aspect, the third aspect, or the possible implementations of the second aspect and the third aspect.

According to a twenty-seventh aspect, a chip is provided, including a processor configured to read instructions stored in a memory. When the processor executes the instructions, the chip is enabled to implement the method according to any one of the fourth aspect, the fifth aspect, or the possible implementations of the fourth aspect and the fifth aspect.

According to a twenty-eighth aspect, a chip is provided, including a processor configured to read instructions stored in a memory. When the processor executes the instructions, the chip is enabled to implement the method according to any one of the sixth aspect or the possible implementations of the sixth aspect.

### BRIEF DESCRIPTION OF DRAWINGS

FIG. 1 is a diagram of a communication system usable in an embodiment;

FIG. 2 is a diagram of an OAuth 2.0-based communication method according to an embodiment;

FIG. 3 is a diagram of a communication method integrated with trustworthiness measurement according to an embodiment;

FIG. 4 is a diagram of another communication method integrated with trustworthiness measurement according to an embodiment;

FIG. 5 is a diagram of still another communication method integrated with trustworthiness measurement according to an embodiment;

FIG. 6 is a diagram of still another communication method integrated with trustworthiness measurement according to an embodiment;

FIG. 7 is a diagram of still another communication method integrated with trustworthiness measurement according to an embodiment;

FIG. 8 is a diagram of still another communication method integrated with trustworthiness measurement according to an embodiment;

FIG. 9 is a diagram of still another communication method integrated with trustworthiness measurement according to an embodiment;

FIG. 10 is a diagram of still another communication method integrated with trustworthiness measurement according to an embodiment;

FIG. 11 is a diagram of still another communication method integrated with trustworthiness measurement according to an embodiment;

FIG. 12 is a diagram of still another communication method integrated with trustworthiness measurement according to an embodiment;

FIG. 13 is a diagram of still another communication method integrated with trustworthiness measurement according to an embodiment;

FIG. 14 is a diagram of still another communication method integrated with trustworthiness measurement according to an embodiment;

FIG. 15 is a diagram of still another communication method integrated with trustworthiness measurement according to an embodiment;

FIG. 16 is a diagram of still another communication method integrated with trustworthiness measurement according to an embodiment;

FIG. 17 is a diagram of still another communication method integrated with trustworthiness measurement according to an embodiment;

FIG. 18 is a diagram of still another communication method integrated with trustworthiness measurement according to an embodiment;

FIG. 19 is a diagram of still another communication method integrated with trustworthiness measurement according to an embodiment;

FIG. 20 is a diagram of still another communication method integrated with trustworthiness measurement according to an embodiment;

FIG. 21 is a diagram of a communication apparatus according to an embodiment; and

FIG. 22 is a diagram of a communication device according to an embodiment.

### DETAILED DESCRIPTION OF EMBODIMENTS

The following describes the solutions of the embodiments with reference to the accompanying drawings.

The solutions of embodiments may be applied to various communication systems, for example, a global system for mobile communications (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, a universal mobile telecommunications system (UMTS), a worldwide interoperability for microwave access (WiMAX) communication system, or a 5th generation (5G) system.

Terminal equipment in embodiments may be user equipment, an access terminal, a subscriber unit, a subscriber station, a mobile station, a remote station, a remote terminal, a mobile device, a user terminal, a terminal, a wireless communication device, a user agent, or a user apparatus. The terminal equipment may alternatively be a cellular phone, a cordless phone, a session initiation protocol (SIP) phone, a wireless local loop (WLL) station, a personal digital assistant (PDA), a handheld device or a computing device having a wireless communication function, another processing device connected to a wireless modem, a vehicle-mounted device, a wearable device, terminal equipment in a 5G network, terminal equipment in a future evolved public land mobile network (PLMN), or the like. This is not limited.

A network device in embodiments may be a device configured to communicate with the terminal equipment. The network device may be a base transceiver station (BTS) in the global system for mobile communications (GSM) or the code division multiple access (CDMA) system, may be a NodeB (NB) in the wideband code division multiple access (WCDMA) system, may be an evolved NodeB (e eNB or eNodeB) in the LTE system, or may be a radio controller in a cloud radio access network (CRAN) scenario. Alternatively, the network device may be a relay station, an access point, a vehicle-mounted device, a wearable device, a network device in the 5G network, a network device in the PLMN network, or the like. This is not limited in embodiments.

In embodiments, unless otherwise specified, a quantity of nouns indicates “a singular noun or a plural noun”, such as “one or more”. “At least one” means one or more, “a plurality of” means two or more, and similarly, “a plurality of types” in “one or more types” means two or more types. “And/or” describes an association relationship between associated objects, and represents that three relationships may exist. For example, A and/or B may represent the following cases: only A exists, both A and B exist, and only B exists, where A and B may be singular or plural. The character “/” generally indicates an “or” relationship between the associated objects. For example, A/B indicates A or B. “At least one of the following items (pieces)” or a similar expression thereof means any combination of these items, including any combination of singular items (pieces) or plural items (pieces). For example, at least one (piece) of a, b, or c represents: a, b, c, a and b, a and c, b and c, or a, b, and c, where a, b, and c may be singular or plural.

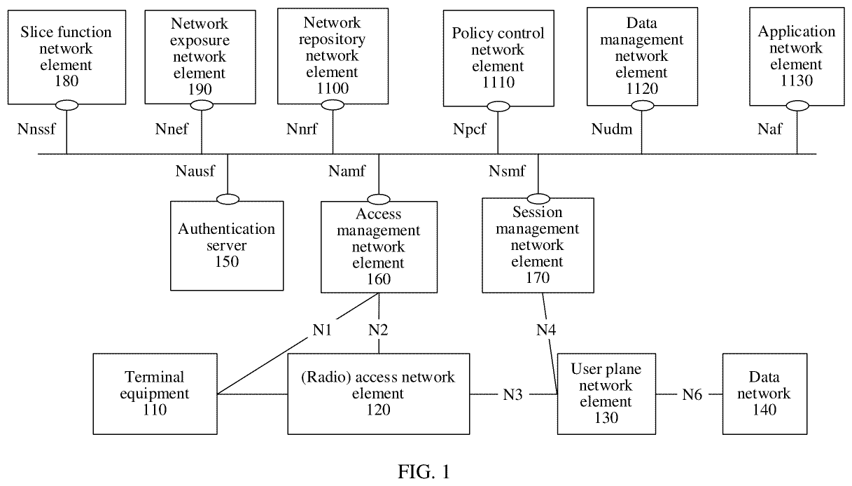

For case of understanding of embodiments, a communication system usable in embodiments is first briefly described with reference to FIG. 1.

FIG. 1 shows a network architecture applied to an embodiment. As shown in FIG. 1, the following separately describes parts in the network architecture.

1. Terminal equipment 110 is an entry for a mobile user to interact with a network, and can provide a basic computing capability and storage capability, display a service window to the user, and receive an operation input from the user. The terminal equipment may include various handheld devices, vehicle-mounted devices, wearable devices, and computing devices that have a wireless communication function or other processing devices connected to a wireless modem, and terminals in various forms, such as a mobile station (MS), user equipment (UE), and a software terminal, for example, a water meter, an electricity meter, and a sensor.

2. A (radio) access network ((R)AN) network element 120 is configured to provide a network access function to authorized terminal equipment in a specific area, and can use transmission tunnels with different quality based on a level, a service requirement, and the like of the terminal equipment.

The (R) AN network element can manage radio resources and provide an access service to the terminal equipment, to complete forwarding of a control signal and data of the terminal equipment between the terminal equipment and a core network. The (R) AN network element may also be understood as a base station in a conventional network.

3. A user plane network element 130 is for packet routing and forwarding, quality of service (QOS) handling on user plane data, and the like.

In a 5G communication system, the user plane network element may be a user plane function (UPF) network element. In a future communication system, the user plane network element may still be the UPF network element, or may have another name. This is not limited.

4. A data network 140 is a data network that provides a service to a user. Generally, a client is in the UE, and a server is in the data network. The data network may be a private network, for example, a local area network; may be an external network that is not controlled by an operator, for example, the Internet; or may be a dedicated network jointly deployed by operators, for example, a network that provides an IMS service.

In the 5G communication system, the data network may be the data network (DN). In the future communication system, the data network may still be the DN, or may have another name. This is not limited.

5. An authentication server 150 is for an authentication service and key generation for bidirectional authentication on the terminal equipment, and supports a unified authentication framework.

In the 5G communication system, the authentication server may be an authentication server function (AUSF) network element. In the future communication system, the authentication server function network element may still be the AUSF network element, or may have another name. This is not limited.

6. An access management network element 160 may be for mobility management, access management, and the like, and may be configured to implement functions, for example, interception and access authorization/authentication, other than session management in functions of a mobility management entity (MME).

In the 5G communication system, the access management network element may be an access and mobility management function (AMF) network element. In the future communication system, the access management network element may still be the AMF network element, or may have another name. This is not limited.

7. A session management network element 170 may be for session management, Internet protocol (IP) address assignment and management of the terminal equipment, selection and management of a user device plane function, termination of interfaces towards a policy control function and a charging function, downlink data notification, and the like.

In the 5G communication system, the session management network element may be a session management function (SMF) network element. In the future communication system, the session management network element may still be the SMF network element, or may have another name. This is not limited.

8. A slice selection network element 180 is configured to select a group of network slice instances that serve the terminal equipment, and determine a group of access management network elements that serve the terminal equipment.

In the 5G communication system, the slice selection network element may be a network slice selection function (NSSF) network element. In the future communication system, the slice selection network element may still be the NSSF network element, or may have another name. This is not limited.

9. A network exposure network element 190 is configured to expose a network capability to a third-party disclosure, to implement friendly interconnection between the network capability and a service requirement.

In the 5G communication system, the network exposure network element may be a network exposure function (NEF) network element. In the future communication system, the network exposure network element may still be the NEF network element, or may have another name. This is not limited.

10. A network repository network element 1100 is configured to maintain real-time information of all network function services in the network.

In the 5G communication system, the network repository network element may be a network registration function (NRF) network element. In the future communication system, the network repository network element may still be the NRF network element, or may have another name. This is not limited.

11. A policy control network element 1110 is for a unified policy framework to govern network behavior, providing of policy rule information for a control plane function network element (for example, the AMF or the SMF network element), and the like.

In a 4G communication system, the policy control network element may be a policy and charging rules function (PCRF) network element. In the 5G communication system, the policy control network element may be a policy control function (PCF) network element. In the future communication system, the policy control network element may still be the PCF network element, or may have another name. This is not limited.

12. A data management network element 1120 is for handling of an identifier of the terminal equipment, access authentication, registration, mobility management, and the like.

In the 5G communication system, the data management network element may be a unified data management (UDM) network element. In the future communication system, the unified data management network element may still be the UDM network element, or may have another name. This is not limited.

13. An application network element 1130 is for application influence on data routing, access to the network, interaction with a policy framework to perform policy control, and the like.

In the 5G communication system, the application network element may be an application function (AF) network element. In the future communication system, the application network element may still be the AF network element, or may have another name. This is not limited.

It may be understood that the foregoing network element or function may be a network element in a hardware device, a software function running on dedicated hardware, or a virtualization function instantiated on a platform (for example, a cloud platform). The foregoing network element or function may be divided into one or more services. Further, a service independent of the network function may occur.

Further, the AF network element is referred to as an AF for short, the NEF network element is referred to as a NEF for short, the NRF network element is referred to as an NRF for short, and the PCF network element is referred to as a PCF for short. In other words, in the following descriptions of this embodiments, the AF may be replaced with the application network element, the NEF may be replaced with the network exposure network element, the NRF may be replaced with the network repository network element, and the PCF may be replaced with the policy control network element.

An open authorization (OAuth) protocol is an open Internet protocol about authorization. OAuth allows a user to authorize, without providing a user name and a password to a third-party application or sharing all content of user data, the third-party application to access information stored by the user in another service provider. The OAuth protocol relates to three roles: a service provider, a resource owner, and the third-party application (a client). The service provider may be logically classified into an authorization server and a resource server, and the authorization server and the resource server may be a same application.

The authorization server is configured to perform authentication on an identity of the user and generate a token.

The resource server is configured to store a resource of the user and verify the token.

The resource owner is a user who owns the resource.

The third-party application requests to access data of the user on another service provider.

The OAuth protocol includes four modes of authorizing the third-party application, including: an authorization code mode, an implicit mode, a resource owner password credentials mode, and a client credentials mode. The authorization code mode has complete functions and strict logic.

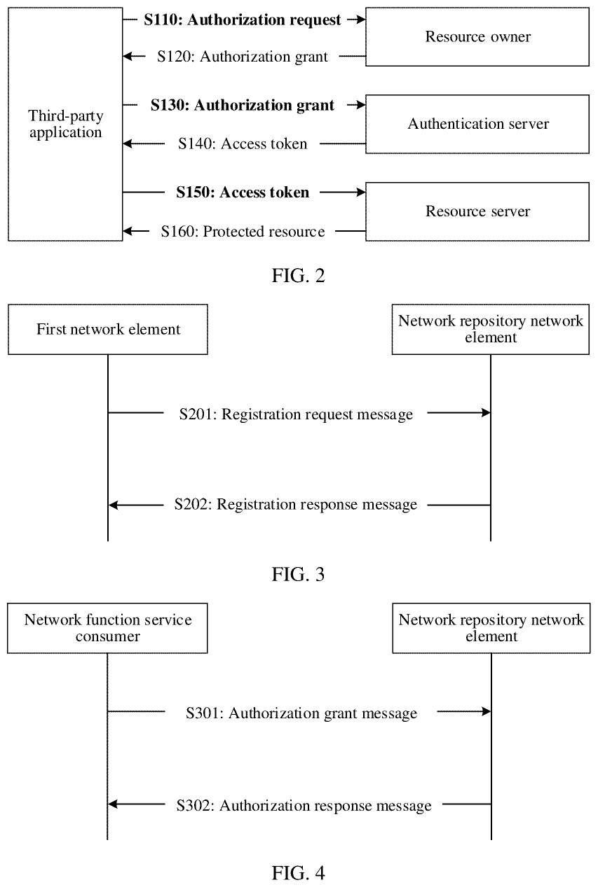

FIG. 2 shows an OAuth 2.0-based communication method to which an embodiment is applicable.

S110: A third-party application requests a resource owner to authorize the third-party application to access data of the resource owner stored in another service provider.

S120: The resource owner authorizes the third-party application to access the data of the resource owner stored in the another service provider.

S130: The third-party application applies to an authorization server for an access token based on the authorization obtained in S120.

S140: The authorization server performs authentication on the third-party application, and delivers the access token to the third-party application after determining that the third-party application is authenticated.

S150: The third-party application applies to, by using the access token, a resource server for obtaining the data of the resource owner.

S160: The resource server determines that the access token of the third-party application is correct, and agrees to open the data of the resource owner to the third-party application.

Trusted computing (TC) is a technology that aims to enable a computer to always run as expected. “Trusted” emphasizes that a behavior result is predictable and controllable. The trusted computing is enforced by computer hardware and software. A trusted technology for a computing system starts with a root of trust and develops to trusting a hardware platform, an operating system, and an application. Management and authentication strength of each layer corresponds to trustworthiness of each layer. Further, the trustworthiness is extended to the complete computer system, and a protection measure is taken to ensure integrity of computer resources and expected computer behavior, to improve the trustworthiness of the computer system.

At present, the trusted computing includes two different research directions. One is to use a physical anti-tampering device to ensure that a trusted computing base (TCB) is trusted and use the TCB as a trusted anchor to build a trusted computing architecture for the computer system. The other one is to build an isolated computing system to ensure that a running environment of specific sensitive software code is trusted. Based on this idea, a universal trusted execution environment (TEE) based on a special security mode of a central processing unit (CPU) is developed.

Remote attestation (RA) is one of key technologies in an overall solution for the trusted computing, and is used to determine whether a device is trusted. The remote attestation enables a user or another person to detect a change of a computer of the user. In this way, private information or an important command is not sent to an insecure computer or a security-compromised computer. In a remote attestation mechanism, a certificate is generated by using hardware, to declare which software is running. The user may send the certificate to a remote party to indicate that the computer of the user is not tampered with. The remote attestation can be combined with public-key encryption, to ensure that sent information can be read only by a program that sends an attestation request rather than another eavesdropper. These restrictions are used to achieve objectives of enhancing terminal trustworthiness and improving system security. Currently, a remote attestation technology uses the following several solutions:
(1) Privacy certificate authority (PCA): A challenger sends a challenge to a trusted platform module (TPM), for example, requests content of one or more platform status registers (PCRs). The platform collects a storage measurement log (e.g. attestation report) file, and the TPM signs the content of the PCR by using an identity key. The platform sends, to a certificate agent (CA), a message for requesting a platform certificate, and then sends the platform certificate, the storage measurement log (e.g. attestation report), and the signed PCR to the challenger. The challenger attests the request, for example, recalculates a storage measurement log and compares the storage measurement log (e.g. attestation report) with a received PCR value to verify the platform certificate and a signature.
(2) Direct anonymous attestation (DAA): The TPM selects one piece of secret information, and obtains, through a secure zero-knowledge protocol, a DAA certificate issued by a DAA issuer for the secret information. A verifier proves, through a “zero-knowledge proof”, that the TPM has a trusted and valid DAA certificate.
(3) Intel software guard extensions (Intel SGX) cross-platform verification: An SGX technology enables a developer to partition an application into a hardened enclave of a central processing unit (CPU) or an executable protected area in a memory, to improve security even on an attacked platform. An Intel SGX solution is approximately as follows: An authenticated enclave obtains current information to generate a report structure, generates a tag by using a report key of a quote enclave (QE), and sends the report structure and the tag to the quote enclave. The quote enclave verifies whether the authenticated enclave and the quote enclave are on a same platform (for example, a same device), encapsulates the received report structure into a quote structure, and signs the quote structure by using a signature key. A target enclave verifies whether a quote is generated by a reliable Intel processor.

The OAuth 2.0 protocol requires the authorization server to perform identity authentication on the client, but does not specify an identity authentication method. This makes it possible to integrate the remote attestation technology of the trusted computing. Compared with another authentication technology, the trusted computing technology can provide a trusted running environment for an OAuth 2.0 entity in terms of hardware, and has a higher security capability.
Before embodiments are formally described, some terminologies that may be used in embodiments are first described.

1. Enclave: is an area for separating and encrypting code data, where the code data is decrypted only within a processor. The enclave is a part of an application and has full access to a memory of the application.

2. Quote enclave (QE): An enclave provided by Intel is referred to as the quote enclave. When an enclave system is running, only the quote enclave can access an asymmetric key specific to a device.

3. Trusted platform module (TPM): is a chip planted inside a computer to provide a root of trust to the computer.

4. TPM software stack (TSS): is a software specification that provides a standard application programming interface (API) for accessing a TPM function. An application developer may use the software specification to develop an interoperable client application to implement stronger tamper-resistant computing.

5. Digital certificate: is also referred to as a public key certificate or an identity certificate, and is an electronic document for public key infrastructure, to attest an identity of a public key owner. The document includes public key information, owner identity information (a subject), and a digital signature of a digital certificate authority (an issuer) on the document, to ensure that overall content of the document is correct. With the document, the owner may reveal the identity to a computer system or another user, so that the owner is trusted by the computer system or the another user and authorized to access or use some sensitive computer services. The computer system or the another user may verify the content of the certificate by using a specific program, where the content includes whether the certificate expires and whether the digital signature is valid. If the computer system or the another user trusts the issuing authority, the computer system or the another user may trust a key on the certificate, and perform reliable communication with the owner through public-key encryption.

In short, the authority applies, by using a private key of the authority, a digital signature to a public key of a person (or an organization) on which authentication needs to be performed, and generates a certificate. In other words, the essence of the certificate is to apply the digital signature to the public key.

6. Certificate signing request (CSR): is a message sent by an applicant to a certificate authority to apply for a public key certificate, and can include a public key for certificate issuing, identifying information (such as a domain name), and integrity protection (such as a digital signature). When the certificate is signed, the two parts are both inserted into the certificate.

7. Certificate authority (CA): is also referred to as an e-commerce authentication center or an e-commerce authentication and authorization authority, and is an authority responsible for issuing and managing a digital certificate; and as a trusted third party in an e-commerce transaction, is responsible for verifying trustworthiness of a public key in a public key system.

8. Trusted execution environment (TEE): is a secure area in a central processing unit, and can ensure that a program and a material in the TEE are protected in terms of confidentiality and integrity. The TEE is an isolated execution environment, and may provide security features such as isolated execution, integrity of an application that is executed with the TEE, and confidentiality of assets of the application. In a general term, the TEE provides more secure execution space for execution of trusted software, is more secure than an operating system, and has more functionality than a secure element.

9. Endorsement key (EK): is a public and private key pair written by a manufacturer during manufacturing of the TPM. The EK is a unique identifier of the TPM. However, in consideration of user privacy, the EK cannot be directly for encrypting and signing data. One of main functions of the EK is to generate an attestation identity key, where the attestation identity key is for replacing the EK to encrypt and sign the data.

10. Attestation identity key (AIK): may be for encrypting and signing data to attest existence of the TPM. The AIK is bound to the EK. However, a device other than a platform on which the TPM is located and the PCA cannot obtain a correspondence between the AIK and the EK. This ensures the user privacy.

Timestamp: is data generated by using a digital signature technology. A signature object includes information such as original file information, a signature parameter, and signature time.

11. TrustZone: is a security solution. TrustZone provides an independent secure operating system and hardware virtualization technology to provide a trusted execution environment for security of a mobile phone. TrustZone enables two independent execution environments to run on a same set of hardware systems, where the two execution environments are respectively referred to as a secure world and a normal world.

12. Trusted cryptography module (TCM): is a module of a trusted computing platform, provides a cryptographic computing function for the trusted computing platform, and has protected storage space.

With reference to a service scenario of a core network element, the following describes a communication method provided in the embodiments. It should be understood that the communication method provided in the embodiments may be further applied to a scenario other than the core network service scenario. The following embodiments constitute no limitation on an application scenario of the communication method provided in the embodiments.

Currently, no dedicated protection measure is set for security of the core network element. With reference to FIG. 3 to FIG. 20, the following describes how to enhance the security of the core network element and security of signaling exchange between network elements by using a communication method integrated with trustworthiness measurement provided in the embodiments.

FIG. 3 is a schematic flowchart of initial registration of a network element.

Before a network function service provider of a core network provides a network element service to a network function service consumer, both the network function service consumer and the network function service provider need to be registered with a network repository network element. The following uses a registration process of a first network element as an example to describe the communication method provided in embodiments. Registration processes of the network function service consumer and the network function service provider are similar to the registration process of the first network element. For brevity, descriptions are not repeated herein.

S201: The first network element sends a registration request message.

The registration request (e.g. registration_request) message is used to request to register the first network element.

In some embodiments, in addition to requesting to register the first network element, the registration request message may further include information related to trustworthiness attestation. After obtaining the information related to the trustworthiness attestation, a receiver of the registration request message may perform a remote attestation-related operation.

In some embodiments, the registration request message includes trusted-platform identification information, and the trusted-platform identification information indicates a trusted-platform type of the first network element.

In some embodiments, the registration request message includes a network function profile (NF Profile), and the trusted-platform identification information is included in the NF profile.

In some embodiments, the trusted-platform identification information of the first network element may be preconfigured on the network repository network element before the first network element sends the registration request. In this way, the registration request message may not include the trusted-platform identification information.

After determining a trusted platform supported by the first network element, the network repository network element may determine, for the trusted platform, how to perform trustworthiness verification on the first network element. When the first network element supports more than one trusted platform, the network repository network element may determine and preferentially select a verification manner based on another factor, for example, verification efficiency or a network status, to verify the first network element.

S202: The first network element receives a registration response message.

The registration response (e.g. registration_response) message is used to respond to the registration request message.

In some embodiments, the registration response message further indicates a verification result of a first certificate, and the first certificate is for verifying whether a first trusted platform of the first network element is trusted.

In some embodiments, the registration response message includes a first trusted certificate of the first network element, and the first trusted certificate is for attesting that the first trusted platform is trusted.

In some embodiments, the network repository network element may determine, based on the trusted platform of the first network element, whether a certificate needs to be issued to the trusted platform of the first network element. For a specific trusted platform, a trusted certificate does not need to be issued, and the registration response message does not need to include the trusted certificate.

In some embodiments, the registration response message indicates that the first certificate fails to be verified. In this case, the registration response message may also be referred to as a registration reject message.

In some embodiments, after receiving the registration response message indicating that the first certificate fails to be verified, the first network element sends a re-registration request message, where the re-registration request message is used to request to register the first network element, and includes a second certificate, and the second certificate is for verifying whether a second trusted platform of the first network element is trusted.

The registration response message includes the verification result of the first certificate of the first network element, and the first network element may determine, after receiving the registration response message, whether the registration is completed. When the registration succeeds, the first network element may obtain the first trusted certificate, where the trusted certificate may be used as proof of identification of the first network element. When the registration fails, the first network element may determine that the registration failure is caused by the failure in verifying the first certificate of the first trusted platform, and then prepare a next registration request by changing the trusted platform or in another manner. Implementation of this solution helps improve registration efficiency of the first network element.

After the registration is completed, if the network function service consumer needs to obtain the service provided by the network function service provider, the network function service consumer requests to obtain an access token from the network repository network element, for example, performs an authorization request. The network function service consumer may access, by using the access token, the service provided by the network function service provider. FIG. 4 is a schematic flowchart of the authorization request performed by the network function service consumer.

S301: The network function service consumer sends an authorization grant message.

The authorization grant (e.g. authorization_grant) message is used to request to obtain the access token, and the access token includes information about a service that the network service function consumer is authorized to access.

In some embodiments, the authorization grant message further includes a second trusted certificate, and the second trusted certificate is for verifying whether a trusted platform of the network function service consumer is trusted.

In some embodiments, the authorization grant message further includes first attestation information, and the first attestation information is generated based on first challenge data, and is for attesting whether the network function service consumer is trusted.

In some embodiments, the network function service consumer receives the first challenge data, where the first challenge data is for generating the first attestation information.

In some embodiments, the first challenge data is any one of a timestamp, a first random number, a second random number, and a value of an agreed field, the first random number is a random number provided by a trusted third party, and the second random number is a random number generated for verifying whether the trusted platform of the network function service consumer is trusted.

In an embodiment, the first challenge data is the timestamp, and the timestamp is clock information trusted by both the network function service consumer and the network repository network element.

For example, the first challenge data is clock information generated by a TPM trusted platform of the network function service consumer.

In an embodiment, the first challenge data is the value of the agreed field, and the agreed field may be determined according to an Internet protocol that both the network function service consumer and the network repository network element comply with.

For example, it is specified in the OAuth 2.0 protocol that bit data of the 256^{th} to 320^{th} bits of the authorization grant message is used as the challenge data, and both the network function service consumer and the network repository network element comply with the OAuth 2.0 protocol. In this case, the network function service consumer obtains the bit data of the 256^{th} to 320^{th} bits of the authorization grant message as the challenge data.

In an embodiment, the first challenge data is the first random number, and the first random number is a random number trusted by both the network function service consumer and the network repository network element.

For example, the first random number is generated by using a blockchain (for example, is a timestamp or a hash value of a latest block in the blockchain), and the network function service consumer uses the first random number as the challenge data after obtaining the first random number.

The timestamp, the value of the agreed field, the first random number, the second random number, and the like are used as a random number for generating the attestation information, so that trustworthiness verification in multiple manners can be implemented. Two parties of the trustworthiness verification may select an appropriate manner based on an actual case to determine the challenge data, to complete the trustworthiness verification. This helps improve adaptability of the communication method integrated with trustworthiness measurement provided in the embodiments to different application scenarios.

In some embodiments, the network function service consumer sends attestation information or an attestation result to the network repository network element based on an agreed trigger mechanism.

In some embodiments, the trigger mechanism is periodic triggering that is based on agreed time or triggering that is in response to a specific event.

In some embodiments, after receiving the first challenge data, the network function service consumer triggers an action of sending the attestation information.

In some embodiments, after receiving first attestation identity information, the network function service consumer triggers an action of sending the attestation result.

In some embodiments, the network function service consumer receives the first attestation identity information, where the first attestation identity information requests to obtain the first attestation information or a second attestation result, the first attestation information is for verifying whether the network function service consumer is trusted, and the second attestation result includes an attestation result indicating that the network function service consumer has been attested to be trusted.

After receiving the first attestation identity information, the network function service consumer may prepare the first attestation information or the second attestation result that are to be used by the network repository network element to verify whether the network function service consumer is trusted.

Because a data amount of identity information may be far less than a data amount of challenge data, triggering trustworthiness attestation by using the identity information helps simplify content of a message. An attester may generate attestation information in an agreed manner. This helps the attester select, based on an actual case, a manner of generating the attestation information.

S302: The network function service consumer receives an authorization response message.

The authorization response (e.g. authorization_response) message indicates a result of the request for obtaining the access token.

In some embodiments, the authorization response message indicates that the access token is obtained, the access token includes a first attestation result, the first attestation result includes a verification result of verifying the first attestation information, and the first attestation information is for verifying whether the network function service consumer is trusted.

The access token including the verification result of the attestation information of the first network element may be used in a subsequent service request procedure. The network function service provider may directly obtain, by using the access token, the result of verifying the attestation information of the network function service consumer by the network repository network element, and does not need to request the network function service consumer to regenerate attestation information. The solution provided in this embodiment can obviously simplify a process of verifying the network function service consumer in the service request procedure, and improve verification efficiency.

In some embodiments, the first attestation result includes one or more of identity information, trusted content, and freshness. The identity information indicates an identity of a verifier, such as the network repository network element, attesting that the network function service consumer is trusted. The trusted content indicates content that is of the network function service consumer and that is attested by the network repository network element to be trusted. The freshness indicates a time period in which the network function service consumer is attested by the network repository network element to be trusted.

The first attestation result includes the identity information of the verifier, the trusted content, and the freshness, so that when the network function service consumer is verified next time, the verifier can directly determine, by using the first attestation result, whether the network function service consumer is trusted. This helps improve efficiency of the trustworthiness attestation.

An identity of the verifier of trustworthiness attestation corresponding to the first attestation result may be determined by using the identity information of the verifier. Specific trusted content attested in the trustworthiness attestation process corresponding to the first attestation result and whether the specific trusted content is applicable to the current trustworthiness attestation may be determined by using the trusted content. A time period in which the trustworthiness attestation corresponding to the first attestation result is completed may be determined by using the freshness, to determine whether the trustworthiness attestation result is within a validity period, and determine whether trustworthiness attestation needs to be performed again.

In some embodiments, the authorization response message indicates that the access token is not obtained, and indicates that the second trusted certificate or the first attestation information fails to be verified.

The authorization response message indicates the result of the request for obtaining the token, so that after receiving the authorization response message, the network function service consumer may determine whether the access token is obtained; and when the access token is not obtained, the network function service consumer may re-prepare a trusted certificate or attestation information for a next authorization and authentication process based on an indication, indicating that the trusted certificate or the attestation information fails to be verified, that is included in the authorization response message. When the access token is obtained, the attestation result included in the access token facilitates the verification in the service request procedure. This embodiment helps improve the verification efficiency in the authorization and authentication process, and facilitates subsequent verification of the network function service consumer.

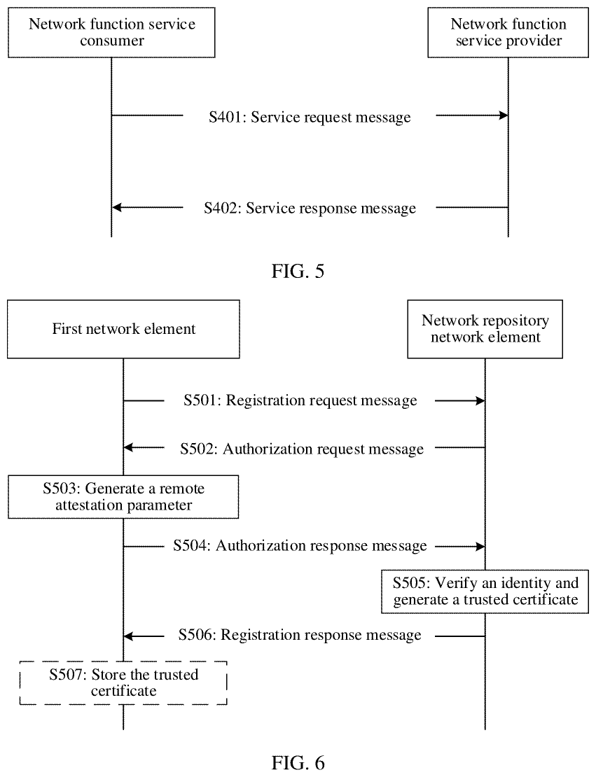

After obtaining the access token, the network function service consumer may use the access token to obtain the network service requested by the network function service consumer. FIG. 5 is a diagram of the service request procedure for the network function service consumer.

S401: The network function service consumer sends a service request message.

The service request (e.g. service_request) message is used to request to obtain the service provided by the network function service provider.

In some embodiments, the service request message further includes second attestation information, and the second attestation information is generated based on second challenge data, and is for verifying whether the network function service consumer is trusted.

In some embodiments, the second challenge data is any one of a timestamp, a first random number, a second random number, and a value of an agreed field.

The timestamp, the value of the agreed field, the first random number, the second random number, and the like are used as a random number, and are for generating the attestation information, so that trustworthiness verification in multiple manners can be implemented. Two parties of the trustworthiness verification may select an appropriate manner based on an actual case to determine the challenge data, to complete the trustworthiness verification. This helps improve adaptability of the communication method integrated with trustworthiness measurement provided in the embodiments to different application scenarios.

In some embodiments, the network function service consumer receives the second challenge data, where the second challenge data is for generating the second attestation information, and the second attestation information is for attesting whether the network function service consumer is trusted.

In some embodiments, the network function service consumer receives second attestation identity information, where the second attestation identity information requests to obtain the second attestation information or a third attestation result, the second attestation information is for verifying whether the network function service consumer is trusted, and the third attestation result includes an attestation result indicating that the network function service consumer has been attested to be trusted.

Because a data amount of identity information may be far less than a data amount of challenge data, triggering trustworthiness attestation by using the identity information helps simplify content of a message. An attester may generate attestation information in an agreed manner. This helps the attester select, based on an actual case, a manner of generating the attestation information.

S402: The network function service consumer receives a service response message.

The service response (e.g. service_response) message indicates whether the service request is accepted, and further indicates a result of the trustworthiness verification of the network function service consumer.

In some embodiments, the service response message indicates that the service request is accepted, the trustworthiness verification includes verification of the second attestation information or the third attestation result, and the second attestation information is for verifying whether the network function service consumer is trusted.

In some embodiments, the trustworthiness verification further includes verification of the first attestation result, and the first attestation result includes an attestation result indicating that the network function service consumer is attested by the network repository network element to be trusted.

In some embodiments, the trustworthiness verification further includes verification of a third trusted certificate, and the third trusted certificate is for verifying whether the trusted platform of the network function service consumer is trusted.

In an embodiment, the second attestation information or the third attestation result of the network function service consumer is first verified, and then the first attestation result is verified. The first attestation result is verified after the second attestation information or the third attestation result is successfully verified.

In an embodiment, the first attestation result of the network function service consumer is first verified, and then the second attestation information or the third attestation result is verified. The second attestation information or the third attestation result is verified when the first attestation result fails to be verified.

When the network function service provider first verifies the first attestation result of the network function service consumer, determines, based on the trusted content of the first attestation result, that the trusted content is applicable to the current verification, and determines, based on the freshness, that the first attestation result is invalid and cannot be used as evidence for attesting that the network function service consumer is trusted, the network function service provider requests to verify the second attestation information or the third attestation result of the network function service consumer.

In an embodiment, both the second attestation information or the third attestation result and the first attestation result of the network function service consumer are successfully verified, and the network function service consumer obtains a network service with complete permission.

In an embodiment, the second attestation information or the third attestation result of the network function service consumer is successfully verified, the first attestation result fails to be verified, and the network function service consumer obtains a network service with restricted permission.

In some embodiments, the service response message indicates that the service request is accepted, the trustworthiness verification is verification of the first attestation result, and the first attestation result includes an attestation result indicating that the network function service consumer is attested by the network repository network element to be trusted.

When the network function service provider first verifies the first attestation result of the network function service consumer, determines, by using the trusted content of the first attestation result, that the trusted content included in the verification result of the network repository network element is applicable to the current verification, and determines, by using the freshness, that the first attestation result is within the validity period and may be used as evidence for attesting that the network function service consumer is trusted, the network function service provider no longer requests to obtain attestation information of the network function service consumer, and may provide the network service to the network function service consumer.

The first attestation result is directly verified, and the attestation information is not first verified. When the attestation result indicating that the network function service user is attested by the network repository network element to be trusted, such as the first attestation result, can be for the current trustworthiness attestation of the network function service consumer, the verification of the network function service consumer in the service request procedure can be obviously accelerated.

In some embodiments, the service response message indicates that the service request is rejected, and further indicates that the third trusted certificate, the second attestation information, the third attestation result, or the first attestation result fails to be verified.

In an embodiment, the trusted platform of the network function service consumer does not need to generate a trusted certificate in a trustworthiness attestation process, and the network function service provider does not verify the trusted certificate in a process of requesting the service by the network function service consumer.

In the solution provided in this embodiment, the verification of the attestation information and the verification of the attestation result are set in the trustworthiness verification. This can implement double verification of the network function service consumer, and provide the service to the network function service consumer based on a verification status, to help improve security of communication between core network elements and security of devices included in the core network function service consumer and provider.

FIG. 6 shows a communication method integrated with trustworthiness measurement according to an embodiment.

In this embodiment, a first network element requests to be registered with a network repository network element, and the network repository network element requests, based on the registration request of the first network element, to perform identity authentication on the first network element.

It should be noted that, in this embodiment, content related to trustworthiness measurement is described, and content related to the OAuth 2.0 protocol is not described in detail.

S501: The first network element sends a registration request message.

The registration request message is used to request to register the first network element.

In some embodiments, the registration request message includes an NF profile, and trusted-platform identification information is included in the NF profile of the first network element.

For example, the trusted-platform identification information may indicate that the first network element supports one or more of a TPM, a TCM, Intel SGX, and TrustZone.

In some embodiments, four binary bits are set as the trusted-platform identification information in the NF profile, to identify a trusted platform supported by the first network element.

For example, 0001 indicates that the first network element supports the TPM, 0010 indicates that the first network element supports the TCM, 0100 indicates that the first network element supports Intel SGX, and 1000 indicates that the first network element supports TrustZone. Correspondingly, 1010 indicates that the first network element supports both TrustZone and the TCM, and 0101 indicates that the first network element supports both Intel SGX and the TPM.

The registration request includes the trusted-platform identification information, so that a receiver of the registration request message can obtain a trusted-platform type supported by the first network element. This helps the receiver of the registration request message verify an identity or a trusted state of the first network element for the trusted-platform type indicated by the first network element, to improve efficiency of verifying the first network element.

S502: The network repository network element sends an authorization request message.

In some embodiments, the first network element requests a trusted certificate from a trusted third party (for example, a PCA), and the authorization request message includes a public key of the network repository network element, where the public key of the network repository network element is for calculating a parameter needed by remote attestation.

In some embodiments, the first network element obtains a trusted certificate of the first network element in a DAA manner, and the authorization request message includes challenge data and a public key of the network repository network element, where the challenge data and the public key of the network repository network element are for calculating a parameter needed by remote attestation.

The authorization request message includes the challenge data, and a receiver of the authorization request message prepares an identity authentication-related parameter and the parameter for the remote attestation based on the authorization request message.

S503: The first network element generates a remote attestation parameter.

The remote attestation parameter generated by the first network element is used by the network repository network element to generate a trusted certificate for the first network element, and is determined based on the trusted platform of the first network element.

In some embodiments, the first network element supports one or more trusted platforms in the TPM, the TCM, Intel SGX, and TrustZone.

In an embodiment, the first network element supports the TPM, and the remote attestation parameter includes an AIK public key and an EK certificate of the TPM.

In an embodiment, the first network element supports the TCM, and the remote attestation parameter includes an AIK public key and an EK certificate of the TPM.

S504: The first network element sends an authorization response message.

In some embodiments, the authorization response message includes the remote attestation parameter generated by the first network element and identity information of the first network element, the remote attestation parameter is for generating the trusted certificate of the first network element, and the identity information is for verifying an identity of the first network element.

In some embodiments, the authorization response message includes the remote attestation parameter, and the remote attestation parameter is for generating the trusted certificate of the first network element and verifying an identity of the first network element.

The first network element may provide, by using the authorization response message, the network repository network element with the parameter for verifying the identity. According to the OAuth 2.0 protocol, the network repository network element may verify the identity of the first network element based on the parameter. Because the authorization response message further includes the remote attestation parameter, the network repository network element may further generate the trusted certificate of the first network element by using the remote attestation parameter. The remote attestation parameter is used as proof of identification of the first network element, so that an amount of data included in the authorization response message can be reduced, thereby facilitating receiving, sending, and processing of the authorization response message.

S505: The network repository network element verifies the identity of the first network element, and generates the trusted certificate.

The network repository network element verifies the identity of the first network element based on the authorization response message.

In some embodiments, the network repository network element verifies the identity of the first network element based on the identity information of the first network element in the authorization response message.

In some embodiments, the network repository network element verifies the identity of the first network element based on the remote attestation parameter in the authorization response message.

In some embodiments, the identity of the first network element and the remote attestation parameter are successfully verified, and the network repository network element generates the trusted certificate.

In some embodiments, the identity of the first network element fails to be verified, and the network repository network element does not generate the trusted certificate.

In an embodiment, the first network element supports the TPM, and the remote attestation parameter included in the authorization response message includes the AIK public key and the EK certificate of the TPM. After verifying that the EK certificate of the TPM is correct, the network repository network element performs signature by using a private key of the network repository network element and the AIK public key to obtain the trusted certificate of the first network element.

S506: The network repository network element sends a registration response message.

The network repository network element sends the registration response message to the first network element after completing the verification of the first network element.

In some embodiments, the identity of the first network element and the remote attestation parameter are successfully verified, and the registration response message includes the trusted certificate generated by the network repository network element.

In an embodiment, the identity of the first network element is successfully verified, and the network repository network element allocates a first network element identifier to the first network element. The first network element identifier may be used as an identifier used by the first network element to subsequently communicate with the network repository network element and a network function service provider.

In an embodiment, the trusted certificate generated by the network repository network element is included in the first network element identifier.

In some embodiments, the identity of the first network element fails to be verified, and the network repository network element sends the registration response message to the first network element, to indicate that the registration fails. In this case, the registration response message may also be referred to as a registration reject message.

In an embodiment, the identity of the first network element is successfully verified, the remote attestation parameter of the first network element fails to be verified, and the registration reject message indicates that the registration fails and a failure cause is that the trusted platform of the first network element is untrusted.

S507: The first network element stores the trusted certificate.

In some embodiments, the network repository network element uses the trusted certificate as proof of identification of the first network element when subsequently verifying the identity of the first network element.

The first network element that has the trusted certificate may directly use the trusted certificate as the proof of identification in the subsequent identity verification. This helps improve efficiency of the identity verification of the first network element.

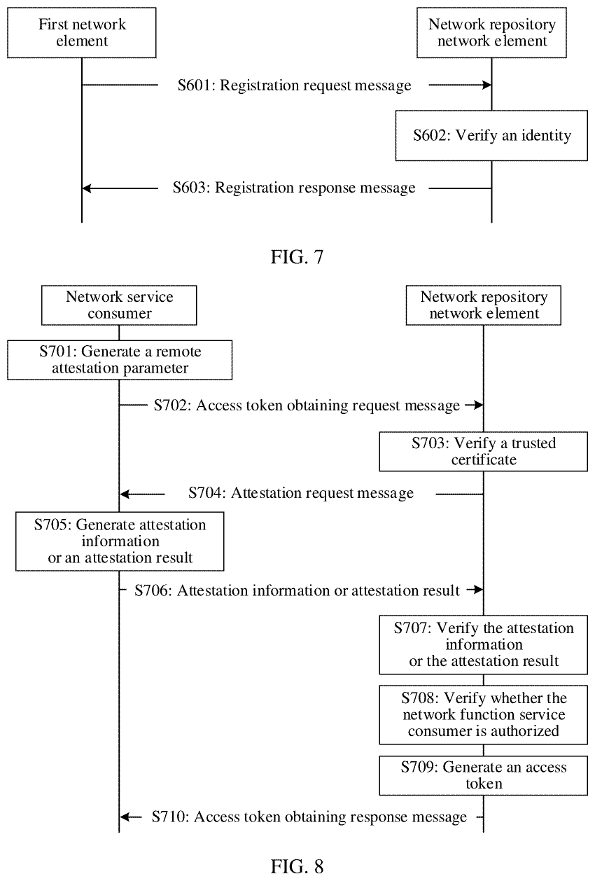

FIG. 7 shows another communication method integrated with trustworthiness measurement according to an embodiment.

In this embodiment, a first network element requests to be registered with a network repository network element; and based on a trusted platform of the first network element, the network repository network element does not need to issue a trusted certificate to the first network element.

S601: The first network element sends a registration request message.

In some embodiments, trusted-platform identification information has been configured on the network repository network element before the first network element sends the registration request message, and the registration request message does not include the trusted-platform identification information.

For an identification manner of the trusted-platform identification information, refer to S501.

The registration request message is sent, so that the network repository network element can obtain a registration request of the first network element. The network repository network element may obtain a trusted-platform type of the first network element based on content of the registration request message or in another manner, and then make a response based on the platform type.

S602: The network repository network element verifies an identity of the first network element.

In some embodiments, the first network element supports an Intel SGX trusted platform, and the network repository network element does not need to sign a trusted certificate for the first network element. After receiving the registration request message of the first network element, the network repository network element verifies the identity of the first network element based on the content of the registration request message.

In some embodiments, the first network element supports an Arm TrustZone trusted platform, and the network repository network element does not need to sign a trusted certificate for the first network element. After receiving the registration request message of the first network element, the network repository network element verifies the identity of the first network element based on the content of the registration request message.

S603: The network repository network element sends a registration response message.

In some embodiments, the identity of the first network element is successfully verified by the network repository network element, and the network repository network element sends the registration response message to the first network element, to indicate that the first network element is successfully registered.

In some embodiments, the identity of the first network element fails to be verified by the network repository network element, and the network repository network element sends a registration reject message to the first network element, to indicate that the first network element fails to be registered.

In some embodiments, the identity of the first network element fails to be verified by the network repository network element, and the network repository network element sends a registration reject message to the first network element, to indicate that the identity of the first network element fails to be verified and the first network element fails to be registered.

With reference to FIG. 6 and FIG. 7, the foregoing uses a registration process of the first network element as an example to describe application of the communication method provided in embodiments to a registration process of a core network element. With reference to FIG. 8 to FIG. 10, the following describes in detail application of the communication method provided in embodiments to an authorization and authentication process of a network function service consumer.

FIG. 8 shows still another communication method integrated with trustworthiness measurement according to an embodiment.

In the method provided in this embodiment, a network function service consumer requests to obtain an access token from a network repository network element, and the network repository network element issues the access token to the network function service consumer after successfully verifying the network function service consumer.

S701: The network function service consumer generates a remote attestation parameter.

The remote attestation parameter generated by the network function service consumer is for generating a trusted certificate, and is determined based on a trusted platform supported by the network function service consumer.

In some embodiments, the network function service consumer supports one or more trusted platforms in a TPM, a TCM, Intel SGX, and Arm TrustZone.

S702: The network function service consumer sends an access token obtaining request message.

The access token obtaining request (e.g. access_token_get_request) message is for initiating, to a receiver of the message, a request for obtaining the access token. The access token obtaining request message includes the remote attestation parameter generated by the network function service consumer and the trusted certificate obtained in a registration process. The trusted certificate is for verifying whether the trusted platform of the network function service consumer is trusted.

In some embodiments, use duration of an access token that has been obtained by the network function service consumer has exceeded timeout duration of the token, and the network function service consumer requests to obtain the access token by using a refresh token.

The access token obtaining request message is sent, so that the network repository network element can obtain a request of the network function service consumer for obtaining the access token. Because the message further includes the trusted certificate of the network function service consumer, the network repository network element may verify the trusted certificate of the network function service consumer after receiving the access token obtaining request message.

S703: The network repository network element verifies the trusted certificate of the network function service consumer.

The trusted certificate includes a signature of the network repository network element and a public key of the network function service consumer in the registration process. After receiving the access token obtaining request message, the network repository network element verifies the signature in the trusted certificate and the public key of the network function service consumer included in the trusted certificate, to verify an identity of the network function service consumer.

S704: The network repository network element sends an attestation request message.

The attestation request message is for sending an attestation request to a receiver of the attestation request message.

In some embodiments, the attestation request message includes challenge data, where the challenge data is for generating attestation information, is a random number, and may be further for anti-replay of the attestation request message.

In some embodiments, the attestation request message includes attestation identity information, and the attestation identity information requests to obtain attestation information or an attestation result.

After verifying that the identity of the network function service consumer is correct, the network repository network element needs to further verify whether software and/or hardware of the network function service consumer are/is trusted. The challenge data is sent to the network function service consumer, so that the network function service consumer can obtain a request of the network repository network element for further requesting to verify data such as a measurement value of the software and/or the hardware of the network function service consumer.

S705: The network function service consumer prepares the attestation information or the attestation result.

The attestation information may also be referred to as attestation evidence or attestation data, and is information that is generated by the network function service consumer in response to the attestation request message and that includes the data such as the measurement value of the software and/or hardware of the network function service consumer.

In some embodiments, the attestation information includes a quote and a measurement log (e.g. event_log). The quote is a digest of the measurement log, and is for verifying whether content of the measurement log is tampered with. The measurement log includes a measurement record of the software and/or the hardware of the network function service consumer.

In an embodiment, the quote is a hash value of the measurement log, and full text of the measurement log may be restored by using the hash value to compare with the measurement log included in the attestation information, to verify the attestation data.

In an embodiment, the network function service consumer supports the TPM trusted platform, the attestation information includes the quote and the measurement log, the quote includes an identifier of a platform configuration register (PCR), a signature of the identifier of the PCR, and the digest of the measurement log, and the measurement log includes the measurement record of the software and/or the hardware of the network function service consumer.

In some embodiments, first attestation information may include one or more of the following information:
a running status, a health degree, security-related configuration or construction information, hardware, firmware, software, a file system, an attestation environment identity, a trusted execution environment, data integrity, and a PCR value of an attester.

The attestation result includes an attestation result indicating that the attester has been attested to be trusted.

In some embodiments, the attestation result includes one or more of identity information, trusted content, and freshness, where the identity information indicates an identity of a verifier of the first attestation information, the trusted content indicates content that is in the first attestation information and that is attested to be trusted, and the freshness indicates a time period in which the first attestation information is verified.

In some embodiments, the attestation result includes one or more of the following information:
configuration: the verifier verifies a configuration of the attester;
executable file (e.g. executables): the verifier verifies a real-time file, a script, and/or another content loaded into a memory that are/is of the attester;
file system (or file-system): the verifier verifies a file system of the attester;
hardware: the verifier verifies hardware and firmware that can sign and run a program of the attester;
attestation environment identity (e.g. instance-identity): the verifier verifies an attestation environment identity of the attester, for example, an AIK of the TPM;
runtime-opaque: the verifier verifies opaque of the verifier from the outside of the memory of the attester;
source data (or sourced-data): the verifier verifies integrity of data used by the attester; and
storage-opaque: the verifier verifies that the attester can encrypt a persistent memory.

S706: The network function service consumer sends the attestation information or the attestation result.

In some embodiments, before sending the attestation information, the network function service consumer encrypts the attestation information by using a private key of the network function service consumer, and information encrypted by using the private key may be decrypted by using a public key corresponding to the private key.

In some embodiments, the attestation information includes one random number for anti-replay of the attestation information.

The attestation information is sent, so that a sender of the attestation request message can obtain the information about the data such as the measurement value of the software and/or the hardware of the network function service consumer, to further determine, based on the attestation information, whether a running environment of the network function service consumer is trusted.

S707: The network repository network element verifies the attestation information.

In some embodiments, the attestation information may be verified by comparing full-text data recovered by using the quote with content of the measurement log.

In some embodiments, the attestation information is encrypted by using the private key of the network function service consumer, and the attestation information can be verified depending on whether the attestation information can be decrypted by using a private key of the network function service consumer that is owned by the network repository network element.

In some embodiments, the attestation information includes the measurement value, the measurement value is data related to a running status of software and/or hardware of the network function service consumer, the measurement log records process information of trustworthiness measurement of the software and/or the hardware of the network function service consumer, and status information may be obtained by performing an operation on the process information. Therefore, the attestation information can be verified by comparing the measurement value in the attestation information with the content of the measurement log.

An identity of a sender of the attestation information, whether the attestation information is complete, whether the attestation information is tampered with, and the like may be determined by verifying the attestation information, to help reduce a probability of a threat that may be caused by the foregoing factors, and help improve security of a core network element.

S708: The network repository network element verifies whether the network function service consumer is authorized.

The network repository network element verifies, according to stipulation of the OAuth 2.0 protocol, whether the network function service consumer is authorized to access a service requested by the network function service consumer.

S709: The network repository network element generates the access token.

The access token (e.g. access_token) indicates that a holder of the access token is permitted to access a resource, data, or a service.

In some embodiments, the access token includes a first attestation result, and the first attestation result includes an attestation result indicating that the network function service consumer is attested by the network repository network element to be trusted.

In some embodiments, the network repository network element does not verify the attestation information of the network function service consumer, but still issues the access token to the network function service consumer. The access token includes a first attestation result, and the first attestation result indicates that the attestation information of the network function service consumer is not verified.

For example, in some scenarios in which a delay requirement for a service of a core network element is high and a security requirement is low, the first attestation result indicates that the attestation information of the network function service consumer fails to be verified.

The attestation result that can be for determining whether the attestation information is successfully verified is added to the access token, so that when the network function service consumer requests to access the service of the core network element, whether the attestation information of the network function service consumer is successfully verified may be verified based on the attestation result in the access token, to implement double verification.

S710: The network repository network element sends an access token obtaining response message.

The access token obtaining response message is used to respond to the access token obtaining request message sent by the network function service consumer. The access token obtaining response message includes the access token issued by the network repository network element.

In some embodiments, the access token obtaining response message further includes a refresh token. The network function service consumer may apply to the network repository network element for a token again by using the refresh token when use duration of the access token exceeds timeout duration of the token.

The access token is obtained, so that the network function service consumer can obtain, from the network function service provider by using the access token, the service requested by the network function service consumer.

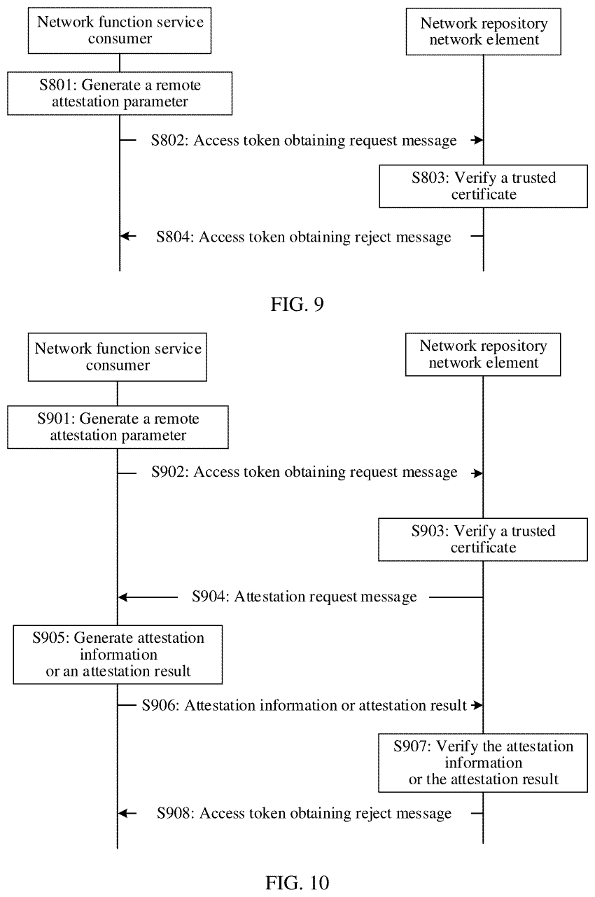

FIG. 9 shows still another communication method integrated with trustworthiness measurement according to an embodiment.

In the method provided in this embodiment, a network function service consumer requests to obtain an access token from a network repository network element, a trusted certificate of the network function service consumer fails to be verified by the network repository network element, and the network repository network element rejects to issue the access token to the network function service consumer.

S801: The network function service consumer generates a remote attestation parameter.

The remote attestation parameter generated by the network function service consumer is used by the network repository network element to generate the trusted certificate for the network function service consumer, and is determined based on a trusted platform supported by the network function service consumer.

In some embodiments, the network function service consumer supports one or more trusted platforms in a TPM, a TCM, Intel SGX, and Arm TrustZone.

S802: The network function service consumer sends an access token obtaining request message.

In some embodiments, the access token obtaining request message is for initiating, to a receiver of the message, a request for obtaining the access token. The access token obtaining request message includes the remote attestation parameter generated by the network function service consumer and the trusted certificate obtained in a registration process.

The access token obtaining request message is sent, so that the network repository network element can obtain the request of the network function service consumer for obtaining the access token. Because the message further includes the trusted certificate of the network function service consumer, the network repository network element may verify the trusted certificate of the network function service consumer after receiving the access token obtaining request message.

S803: The network repository network element verifies the trusted certificate of the network function service consumer.

In some embodiments, the network repository network element queries a signer for a validity period of a signature by using the signature of the trusted certificate, and verifies, based on the validity period, that the trusted certificate is not within the validity period.

In some embodiments, the network repository network element determines, based on signature information of the trusted certificate, that the signature of the trusted certificate does not exist.

In some embodiments, the network repository network element obtains a public key of the network function service consumer based on the trusted certificate, decrypts, by using the public key, encrypted information sent by the network function service consumer, and determines that the encrypted information sent by the network function service consumer cannot be decrypted by using the public key.

The network repository network element verifies authenticity of the trusted certificate of the network function service consumer, to determine whether a next verification step is to be performed on an owner of the trusted certificate or whether to reject a request of the owner of the trusted certificate. This helps improve security of the network repository network element and another network element.

S804: The network repository network element sends an access token obtaining response message.

The message may also be referred to as an access token obtaining reject (e.g. accesstoken_get_reject) message or an authorization reject (e.g. authorization_reject) message. Because the trusted certificate of the network function service consumer fails to be verified, the network repository network element rejects the access token obtaining request of the network function service consumer, and sends the authorization reject message to the network function service consumer.

In some embodiments, the authorization reject message further indicates that the trusted certificate of the network function service consumer fails to be verified.

In a possible case, the network function service consumer forges the signature of the trusted certificate or forges the trusted certificate to attempt to deceive the network repository network element, and may pose a threat to a network, another network element in the network, a user, and the like. Rejecting the network function service consumer helps improve security of the network and the network element.

FIG. 10 shows still another communication method integrated with trustworthiness measurement according to an embodiment.

In the method provided in this embodiment, a network function service consumer requests to obtain an access token from a network repository network element, and sends attestation information to the network repository network element after a trusted certificate is successfully verified, where the attestation information fails to be verified by the network repository network element.

In this embodiment, content of S901 to S906 is consistent with content of S701 to S706. For the specific content, refer to S701 to S706. Details are not described herein again.

S907: The network repository network element verifies the attestation information.

In some embodiments, full-text data restored by using the quote in the attestation information is different from content of the measurement log, and the attestation information fails to be verified.

In some embodiments, the attestation information cannot be decrypted by using a public key of the network function service consumer owned by the network repository network element, and the attestation information fails to be verified.

In some embodiments, the attestation information includes the measurement value, the measurement log is operated to obtain a measurement value that includes a status value of the software and/or the hardware of the network function service consumer, the status value obtained through the operation is different from the measurement value in the attestation information, and the attestation information fails to be verified.

S908: The network repository network element sends an access token obtaining reject message.

Because the attestation information of the network function service consumer fails to be verified, the network repository network element rejects to provide the access token to the network function service consumer, and sends the access token obtaining reject message to the network function service consumer.

In some embodiments, the access token obtaining reject message further indicates that the attestation information of the network function service consumer fails to be verified.

In a possible case, the network function service consumer is an insecure network element or a device that poses a threat, and the trusted certificate forged by the network function service consumer is successfully verified by the network repository network element, but the attestation information forged by the network function service consumer cannot be successfully verified by the network repository network element. Rejecting to issue the access token to the network function service consumer helps improve security of a network, a core network element, user data, and the like.

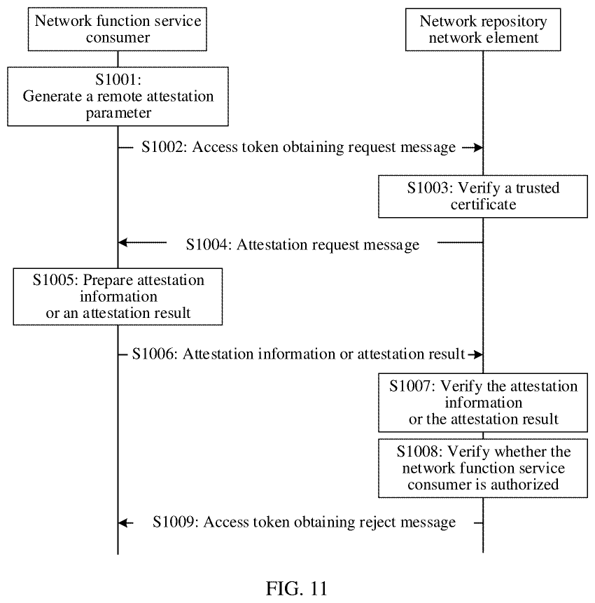

FIG. 11 shows still another communication method integrated with trustworthiness measurement according to an embodiment.

In the method provided in this embodiment, a network function service consumer requests to obtain an access token from a network repository network element, and the network repository network element successfully verifies a trusted certificate and attestation information of the network function service consumer. The network function service consumer is not authorized to apply for the access token, and the network repository network element rejects to issue the access token to the network function service consumer.

In this embodiment, content of S1001 to S1007 is consistent with content of S701 to S707. For the specific content, refer to S701 to S707. Details are not described herein again.

S1008: The network repository network element verifies whether the network function service consumer is authorized.

After the trusted certificate and the attestation information are successfully verified, the network repository network element verifies, according to stipulation of the OAuth 2.0 protocol, that the network function service consumer is not authorized to access a service requested by the network function service consumer. The network repository network element rejects the access token obtaining request of the network function service consumer, and sends an access token obtaining reject message to the network function service consumer.

In some embodiments, the message further indicates that the network function service consumer is not authorized to apply for the access token.

S1009: The network repository network element sends the access token obtaining reject message.

Because the network function service consumer is not authorized, the network repository network element rejects to provide the access token to the network function service consumer, and sends the access token obtaining reject message to the network function service consumer.

In some embodiments, the access token obtaining reject message further indicates that the network function service consumer is not authorized to apply for the access token.

The network repository network element rejects the access token obtaining request of the unauthorized network function service consumer. This helps reduce a service bearer of a network function service provider, helps ensure quality of service to an authorized network function service consumer, and helps improve security of a network, a network element, a network user, and the like.

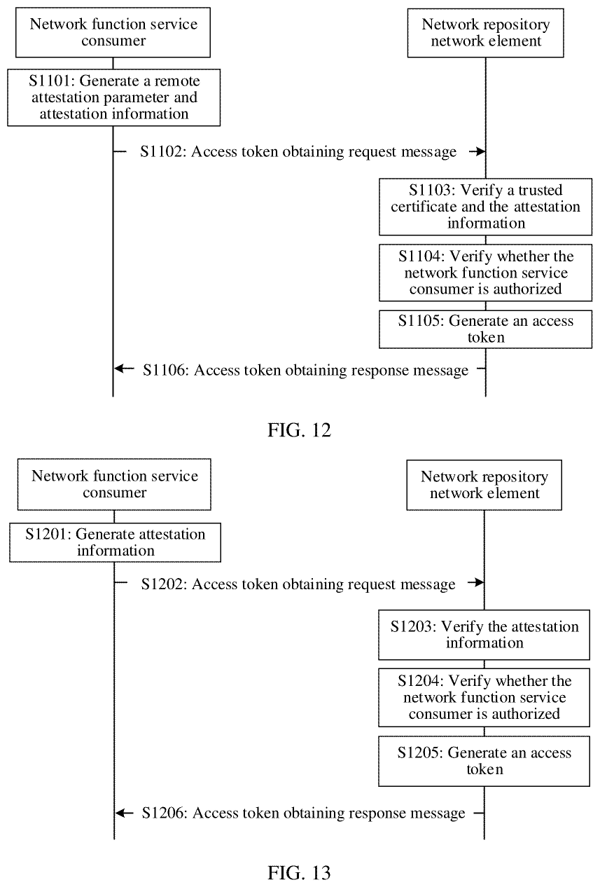

FIG. 12 shows still another communication method integrated with trustworthiness measurement according to an embodiment.

In the method provided in this embodiment, a network function service consumer sends an access token obtaining request message to a network repository network element, to request to obtain an access token. The request message further includes attestation information generated by using challenge data. After receiving the access token obtaining request message, the network repository network element obtains both a trusted certificate and the attestation information. The network repository network element sequentially verifies the trusted certificate, the attestation information, and whether the network function service consumer is authorized. After determining that the foregoing information is correct, the network repository network element issues the access token to the network function service consumer.

S1101: The network function service consumer generates a remote attestation parameter.

The remote attestation parameter generated by the network function service consumer is used by the network repository network element to generate the trusted certificate for the network function service consumer, and is determined based on a trusted platform supported by the network function service consumer.

In some embodiments, the network function service consumer supports one or more trusted platforms in a TPM, a TCM, Intel SGX, and Arm TrustZone.

In some embodiments, the network function service consumer generates the attestation information by using any one of a timestamp, a first random number, a second random number, and a value of an agreed field as the challenge data.

In a possible implementation, the challenge data is the timestamp, and the timestamp is clock information generated by the TPM trusted platform of the network function service consumer.

In a possible implementation, the challenge data is the value of the agreed field, and the agreed field may be determined according to an Internet protocol that both the network function service consumer and the network repository network element comply with.

In a possible implementation, the challenge data is the first random number, and the first random number is a random number trusted by both the network function service consumer and the network repository network element, and may be provided by a trusted third party.

S1102: The network function service consumer sends the access token obtaining request message.

The timestamp, the first random number, the second random number, or the value of the agreed field is used as the challenge data, and the generated attestation information may be sent to the network repository network element when the access token obtaining request message is sent. After receiving the access token obtaining request message, the network repository network element may directly verify the trusted certificate and the attestation information of the network function service consumer. This helps improve information verification efficiency of the network repository network element, and helps the network function service consumer obtain the access token.

S1103: The network repository network element verifies the trusted certificate and the attestation information.

The trusted certificate includes a signature of the network repository network element and a public key of the network function service consumer in a registration process. After receiving the access token obtaining request message, the network repository network element verifies the signature in the trusted certificate and the public key of the network function service consumer included in the trusted certificate, to verify an identity of the network function service consumer.

An identity of a sender of the attestation information, whether the attestation information is complete, whether the attestation information is tampered with, and the like may be determined by verifying the attestation information, to help reduce a probability of a threat that may be caused by the foregoing factors, and help improve security of a core network element.

S1104: The network repository network element verifies whether the network function service consumer is authorized.

The network repository network element verifies, according to stipulation of the OAuth 2.0 protocol, whether the network function service consumer is authorized to access a service requested by the network function service consumer.

S1105: The network repository network element generates the access token.

The access token indicates that a holder of the access token is permitted to access a resource, data, or a service.

In some embodiments, the access token includes first identification information, and the first identification information identifies whether the attestation information of the network function service consumer is verified.

In some embodiments, the network repository network element does not perform remote attestation on the network function service consumer, but still issues the access token to the network function service consumer. The access token includes an attestation result, and the attestation result indicates that the attestation information of the network function service consumer is not verified.

For example, in some scenarios in which a delay requirement for a service of a core network element is high and a security requirement is low, the attestation result identifies that the network function service consumer fails to be verified through the remote attestation.

The attestation result that can be for determining whether the verification through the remote attestation succeeds is added to the access token, so that when the network function service consumer requests to access the service of the core network element, whether the network function service consumer is successfully verified through the remote attestation may be verified based on the attestation result in the access token.

S1106: The network function service consumer sends an access token obtaining response message.

The access token obtaining response message is used to respond to the access token obtaining request message sent by the network function service consumer. The access token obtaining response message includes the access token issued by the network repository network element.

The access token is obtained, so that the network function service consumer can obtain, from a network function service provider by using the access token, the service requested by the network function service consumer.

FIG. 13 shows still another communication method integrated with trustworthiness measurement according to an embodiment.

In this embodiment, when a trusted platform supported by a network function service consumer is registered with a network repository network element, a trusted certificate does not need to be generated. When an access token is applied for, the network repository network element determines, based on the trusted platform supported by the network function service consumer, that there is no need to verify the trusted certificate of the network function service consumer. After determining that attestation information is correct and the network function service consumer has been authorized to apply for the access token, the network repository network element issues the access token to the network function service consumer.

S1201: The network function service consumer generates the attestation information.

In some embodiments, the attestation information is generated by using a timestamp as challenge data.

S1202: The network function service consumer sends an access token obtaining request message.

The timestamp is used as the challenge data, and the generated attestation information may be sent to the network repository network element when the access token obtaining request message is sent. After receiving the access token obtaining request message, the network repository network element may directly verify the attestation information of the network function service consumer. This helps improve information verification efficiency of the network repository network element, and helps the network function service consumer obtain the access token.

S1203: The network repository network element verifies the attestation information.

An identity of a sender of the attestation information, whether the attestation information is complete, whether the attestation information is tampered with, and the like may be determined by verifying the attestation information, to help reduce a threat that may be caused by the foregoing factors, and help improve security of a core network element.

S1204: The network repository network element verifies whether the network function service consumer is authorized.

The network repository network element verifies, according to stipulation of the OAuth 2.0 protocol, whether the network function service consumer is authorized to access a service requested by the network function service consumer.

S1205: The network repository network element generates the access token.

The access token indicates that a holder of the access token is permitted to access a resource, data, or a service.

S1206: The network function service consumer sends an access token obtaining response message.

The access token obtaining response message is used to respond to the access token obtaining request message sent by the network function service consumer. The access token obtaining response message includes the access token issued by the network repository network element.

The access token is obtained, so that the network function service consumer can obtain, from a network function service provider by using the access token, the service requested by the network function service consumer.

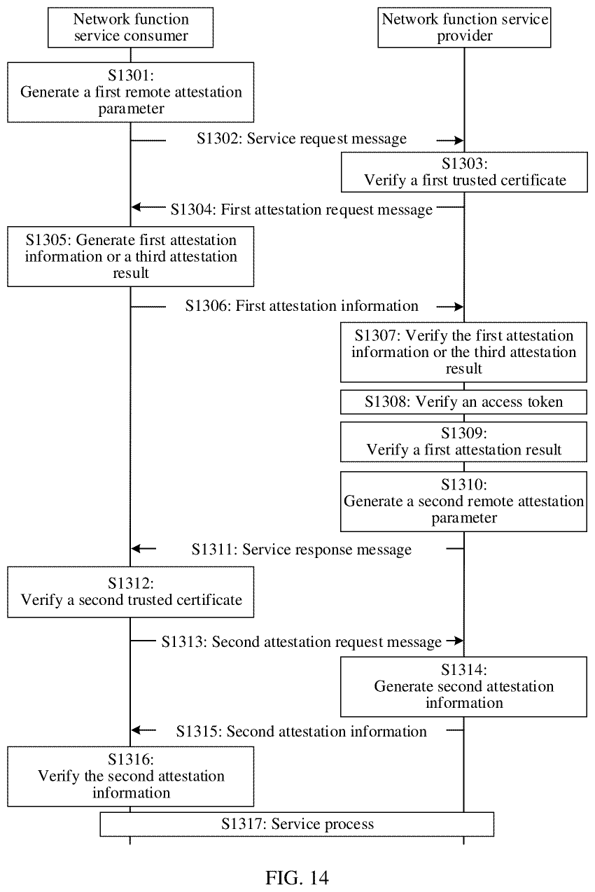

With reference to FIG. 8 to FIG. 13, the foregoing describes application of the communication method provided in embodiments to a process in which the network function service consumer obtains the access token. With reference to FIG. 14 to FIG. 20, the following describes application of the communication method provided in embodiments to a process in which the network function service consumer accesses the network service.

FIG. 14 shows still another communication method integrated with trustworthiness measurement according to an embodiment.

In this embodiment, a network function service consumer requests to access a service provided by a network function service provider, and the network function service provider first verifies the network function service consumer. After the verification performed by the network function service provider succeeds, the network function service consumer submits a verification request to the network function service provider, to verify the network function service provider.

S1301: The network function service consumer generates a first remote attestation parameter.

The first remote attestation parameter is for generating a trusted certificate of the network function service consumer.

S1302: The network function service consumer sends a service request message.

The service request message is used to request to obtain the service from a receiver of the service request. The service request includes an access token obtained in an access token obtaining process, the trusted certificate obtained in a registration process, and the first remote attestation parameter generated in S1301.

S1303: The network function service provider verifies a first trusted certificate of the network function service consumer.

The first trusted certificate is for verifying whether a trusted platform of the network function service consumer is trusted. A method for verifying the first trusted certificate is similar to the method for verifying the trusted certificate in S703. For detailed content, refer to S703. Details are not described herein again.

The network function service provider may determine, by verifying the first trusted certificate of the network function service consumer, whether the trusted platform of the network function service consumer is authentic and trusted.

S1304: The network function service provider sends a first attestation request message.

The first attestation request message is for sending an attestation request to the network function service consumer, to require the network function service consumer to provide data such as a measurement value of software and/or hardware of the network function service consumer, and therefore determine, based on the data such as the measurement value of the software and/or the hardware, whether the network function service consumer is trusted.

S1305: The network function service consumer generates first attestation information.

The first attestation information includes the data such as the measurement value of the software and/or the hardware of the network function service consumer, and the data is for determining whether the network function service consumer is trusted.

A type of information included in the first attestation information is similar to that included in the attestation information described in S705, and details are not described herein again. For specific content, refer to the descriptions in S705.

S1306: The network function service consumer sends the first attestation information.

The first attestation information is sent, so that the network function service provider can obtain information about the data such as the measurement value of the software and/or the hardware of the network function service consumer, to further determine, based on the attestation information, whether the network function service consumer is trusted.

S1307: The network function service provider verifies the first attestation information.

An identity of a sender of the first attestation information, whether the attestation information is complete, whether the attestation information is tampered with, and the like may be determined by verifying the attestation information, to help reduce a probability of a threat that may be caused by the foregoing factors, and help improve security of a core network element.

S1308: The network function service provider verifies the access token of the network function service consumer.

The access token indicates that the network function service consumer is permitted to access a resource, data, or a service.

In some embodiments, the access token includes a first attestation result, and the first attestation result identifies that the first attestation information of the network function service consumer is successfully verified by a network repository network element.

In some embodiments, the access token includes a first attestation result, and the first attestation result identifies that the first attestation information of the network function service consumer fails to be verified by a network repository network element.

The access token of the network function service consumer is verified, to determine whether the network function service consumer has permission to access the service determined by using the access token, determine a type of the service that can be accessed by the network function service consumer, and determine information such as a time period in which the network function service consumer can access the service.

S1309: The network function service provider verifies the first attestation result of the network function service consumer.

In some embodiments, the first attestation result identifies that the first attestation information of the network function service consumer fails to be verified by the network repository network element, and the network function service provider provides a limited service to the network function service consumer.

In some embodiments, the first attestation result identifies that the first attestation information of the network function service consumer is successfully verified by the network repository network element, and the network function service provider provides, to the network function service consumer, the service requested by the network function service consumer.

The first attestation result of the network function service consumer is verified, to further verify, after the access token is verified, whether remote attestation of the network function service consumer succeeds. This implements double verification on whether the remote attestation of the network function service consumer succeeds, and helps enhance protection of the network function service provider.

For an application scenario in which a delay requirement is low or a physical security level of the network function service consumer is high, S1309 may not be performed.

S1310: The network function service provider generates a second remote attestation parameter.

The second remote attestation parameter is for generating a trusted certificate of the network function service provider.

S1311: The network function service provider sends a service response message.

The service response message is used to respond to the service request of the network function service consumer. The service response message includes a second trusted certificate of the network function service provider obtained in the registration process and a parameter for performing remote attestation on the network function service provider.

S1312: The network function service consumer verifies the second trusted certificate of the network function service provider.

The second trusted certificate indicates whether a trusted platform of the network function service provider is trusted. A method for verifying the second trusted certificate is similar to the method for verifying the trusted certificate in S703. For detailed content, refer to S703. Details are not described herein again.

The network function service consumer may determine, by verifying the second trusted certificate of the network function service provider, whether the network function service provider is registered with the network repository network element and whether the trusted platform of the network function service provider is trusted.

S1313: The network function service consumer sends a second attestation request message.

The second attestation request message is for sending an attestation request to the network function service provider, to require the network function service provider to provide data such as a measurement value of software and/or hardware of the network function service provider, to determine, based on the data such as the measurement value of the software and/or the hardware, whether the network function service provider is trusted.

S1314: The network function service provider generates second attestation information.

The second attestation information includes the data such as the measurement value of the software and/or the hardware of the network function service provider, and the data is for determining whether the network function service provider is trusted.

A type of information included in the second attestation information is similar to that included in the attestation information described in S705, and details are not described herein again. For specific content, refer to the descriptions in S705.

S1315: The network function service provider sends the second attestation information.

The second attestation information is sent, so that the network function service consumer can obtain information about the data such as the measurement value of the software and/or the hardware of the network function service provider, to further determine, based on the attestation information, whether the network function service provider is trusted.

S1316: The network function service consumer verifies the second attestation information.

An identity of a sender of the second attestation information, whether the attestation information is complete, whether the attestation information is tampered with, and the like may be determined by verifying the attestation information, to help reduce a threat that may be caused by the foregoing factors, and help improve security of the network function service consumer.

S1317: The network function service consumer establishes a service relationship with the network function service provider.

After determining that the trusted platform of the network function service provider and the network function service provider are trusted, the network function service consumer establishes a connection to the network function service provider, and obtains the requested service from the network function service provider.

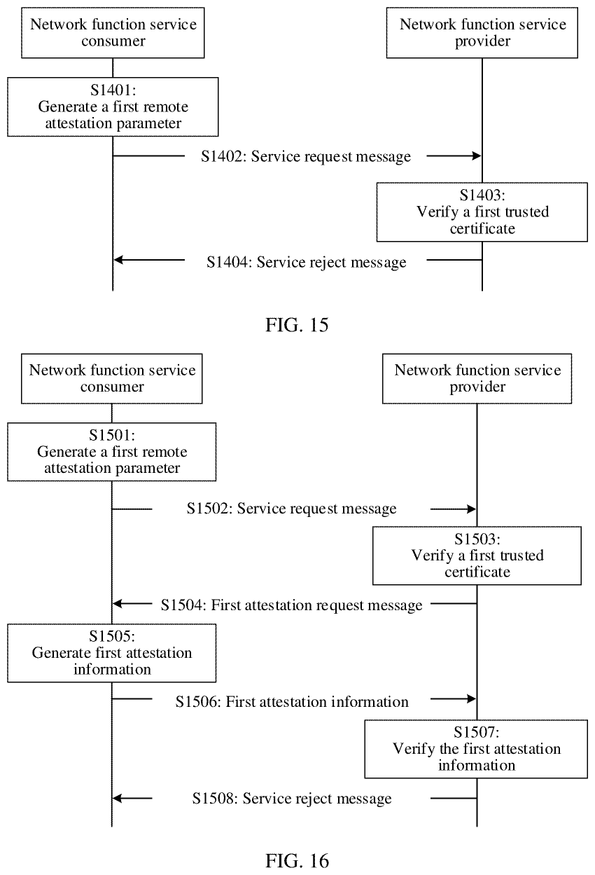

FIG. 15 shows still another communication method integrated with trustworthiness measurement according to an embodiment.

In this embodiment, a network function service consumer requests to access a service provided by a network function service provider. The network function service consumer generates a first remote attestation parameter in S1401, and sends the first remote attestation parameter to the network function service provider in S1402. Content of the two steps is respectively consistent with content of S1301 and S1302, and details are not described herein again.

S1403: The network function service provider verifies a first trusted certificate.

In some embodiments, the network function service provider verifies a signature of the first trusted certificate, and determines that the first trusted certificate is not within a validity period.

In some embodiments, the network function service provider verifies a public key of the first trusted certificate, and determines that encrypted information sent by the network function service consumer cannot be decrypted by using the public key.

S1404: The network function service provider sends a service reject message to the network function service consumer.

Because the first trusted certificate of the network function service consumer fails to be verified, the network function service provider rejects to provide the service to the network function service consumer.

The network function service consumer whose trusted certificate cannot be successfully verified may carry an insecurity factor, and rejecting the network function service consumer helps improve security of a network element and a network.

FIG. 16 shows still another communication method integrated with trustworthiness measurement according to an embodiment.

In this embodiment, a first trusted certificate of a network function service consumer is successfully verified, but first attestation information fails to be verified, and a network function service provider rejects to provide a service to the network function service consumer.

In this embodiment, content of S1501 to S1506 is respectively consistent with content of S1301 to S1306. Details are not described herein again.

S1507: The network function service provider verifies the first attestation information.

In some embodiments, full-text data restored by using a quote in the attestation information is different from content of a measurement log, and the attestation information fails to be verified.

In some embodiments, the attestation information cannot be decrypted by using a public key of the network function service consumer owned by a network repository network element, and the attestation information fails to be verified.

In some embodiments, the attestation information includes the measurement value, the measurement log is operated to obtain a measurement value that includes a status value of the software and/or the hardware of the network function service consumer, the status value obtained through the operation is different from the measurement value in the attestation information, and the attestation information fails to be verified.

S1508: The network function service provider sends a service reject message to the network function service consumer.

Because the first attestation information of the network function service consumer fails to be verified, the network function service provider rejects to provide the service to the network function service consumer.

The network function service consumer whose attestation information cannot be successfully verified may carry an insecurity factor, and rejecting the network function service consumer helps improve security of a network element and a network.

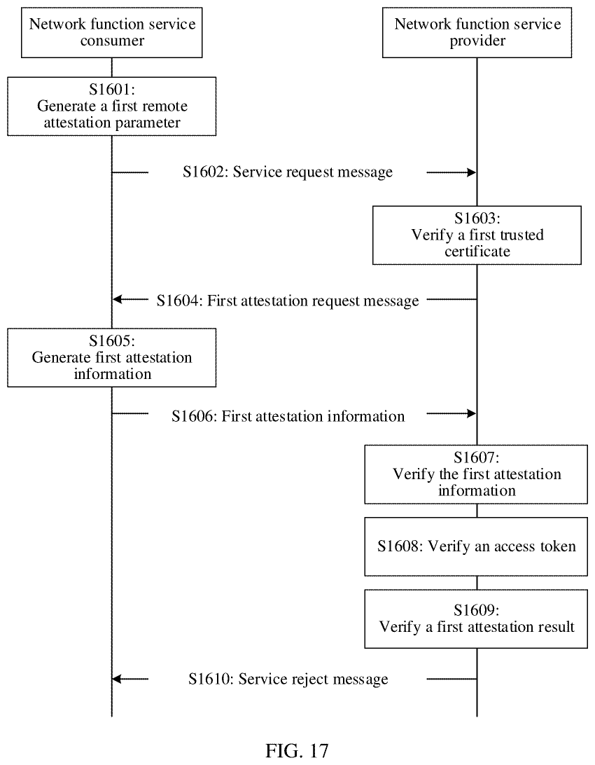

FIG. 17 shows still another communication method integrated with trustworthiness measurement according to an embodiment.

In this embodiment, a first trusted certificate and first attestation information of a network function service consumer are successfully verified, but a third attestation result indicates that attestation information of the network function service consumer is not verified in an authorization phase, and a network function service provider rejects to provide a service to the network function service consumer.

In this embodiment, content of S1601 to S1608 is respectively consistent with content of S1301 to S1308. Details are not described herein again.

S1609: The network function service provider verifies the first attestation result.

The first attestation result indicates whether the attestation information of the network function service consumer is verified by the network repository network element in a process of applying for the access token.

In some embodiments, the first attestation result indicates that trusted information of the network function service consumer fails to be verified by the network repository network element.

In an embodiment, a scenario in which the network function service consumer requests the service has a high delay requirement and a low security requirement, the network repository network element does not verify the attestation information of the network function service consumer, and the first attestation result indicates that the trusted information of the network function service consumer fails to by verified by the network repository network element.

S1610: The network function service provider sends a service reject message to the network function service consumer.

Because the first attestation result of the network function service consumer fails to be verified, the network function service provider rejects to provide the service to the network function service consumer.

The network function service consumer whose first attestation result cannot be successfully verified may carry an insecurity factor, and rejecting the network function service consumer helps improve security of a network element and a network.

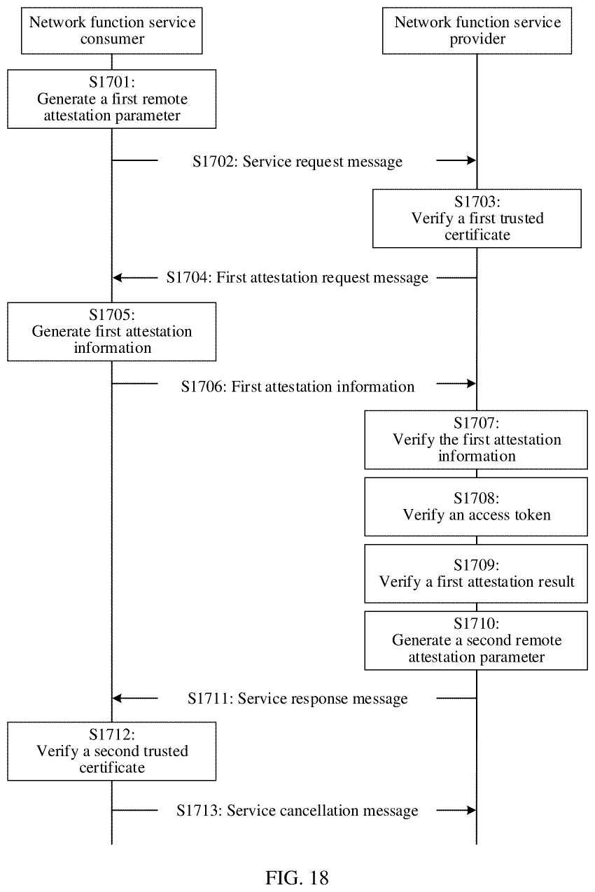

FIG. 18 shows still another communication method integrated with trustworthiness measurement according to an embodiment.

In this embodiment, a network function service consumer is successfully verified by a network function service provider, a trusted certificate of the network function service provider fails to be verified by the network function service consumer, and the network function service consumer cancels obtaining a service from the network function service provider.

In this embodiment, content of S1701 to S1711 is respectively consistent with content of S1301 to S1311. Details are not described herein again.

S1712: The network function service consumer verifies the second trusted certificate.

In some embodiments, the network function service consumer verifies a signature of the second trusted certificate, and determines that the second trusted certificate is not within a validity period.

In some embodiments, the network function service consumer verifies a public key of the second trusted certificate, and determines that encrypted information sent by the network function service provider cannot be decrypted by using the public key.

S1713: The network function service consumer sends a service cancellation message to the network function service provider.

Because the second trusted certificate of the network function service provider fails to be verified, the network function service consumer cancels obtaining the service from the network function service provider.

The network function service provider whose trusted certificate cannot be successfully verified may carry an insecurity factor, and canceling obtaining the service from the network function service provider helps improve security of a network element and a network.

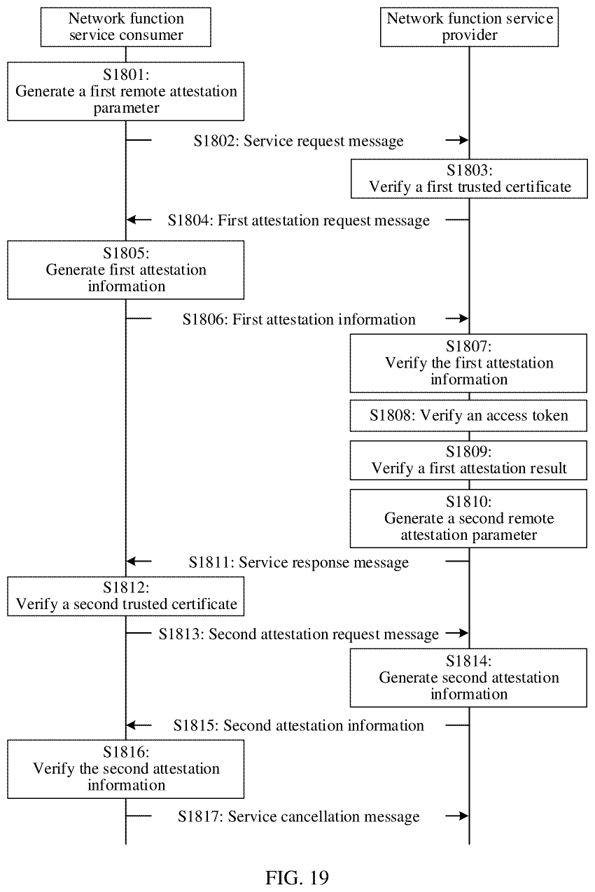

FIG. 19 shows still another communication method integrated with trustworthiness measurement according to an embodiment.

In this embodiment, a network function service consumer is successfully verified by a network function service provider, attestation information of the network function service provider fails to be verified by the network function service consumer, and the network function service consumer cancels obtaining a service from the network function service provider.

In this embodiment, content of S1801 to S1815 is respectively consistent with content of S1301 to S1315. For the specific content, refer to S1301 to S1315. Details are not described herein again.

S1816: The network function service consumer verifies the second attestation information.

In some embodiments, full-text data restored by using a quote in the second attestation information is different from content of a measurement log, and the second attestation information fails to be verified.

In some embodiments, the attestation information cannot be decrypted by using a public key of the network function service provider owned by the network function service consumer, and the attestation information fails to be verified.

In some embodiments, the attestation information includes the measurement value, the measurement log is operated to obtain a measurement value that includes a status value of the software and/or the hardware of the network function service provider, the status value obtained through the operation is different from the measurement value in the attestation information, and the attestation information fails to be verified.

S1817: The network function service consumer sends a service cancellation message to the network function service provider.

Because the second attestation information of the network function service provider fails to be verified, the network function service consumer cancels obtaining the service from the network function service provider.

The network function service provider whose attestation information cannot be successfully verified may carry an insecurity factor, and canceling obtaining the service from the network function service provider helps improve security of a network element and a network.

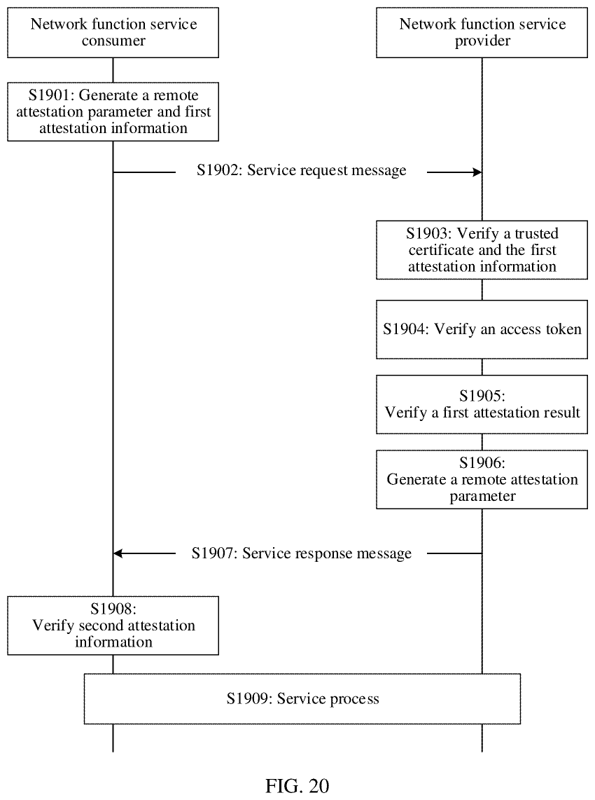

FIG. 20 shows still another communication method integrated with trustworthiness measurement according to an embodiment.

In this embodiment, a network function service consumer requests to obtain a service provided by a network function service provider, and generates attestation information by using a timestamp as challenge data. The network function service provider may verify both a trusted certificate and the attestation information of the network function service consumer, and verify an access token and identification information. After determining that the to-be-verified information of the network function service consumer is correct, the network function service provider generates attestation information based on a trusted platform, and does not need to generate a trusted certificate. The network function service provider sends the attestation information to the network function service consumer by sending a service response message.

After verifying that the attestation information is correct, the network function service consumer obtains the service from the network function service provider.

S1901: The network function service consumer generates a first remote attestation parameter and first attestation information.

In some embodiments, the network function service consumer generates the first attestation information by using the timestamp as the challenge data.

In some embodiments, the timestamp is a time value related to the network function service consumer, for example, a time period in which the network function service consumer receives or sends a specific message.

S1902: The network function service consumer sends a service request message.

The service request message is used to request to obtain the service from a receiver of the service request. The service request includes the access token obtained in an access token obtaining process, the trusted certificate obtained in a registration process, and the first remote attestation parameter and the first attestation information that are generated in S1301.

S1903: The network function service provider verifies a first trusted certificate and the first attestation information.

The first trusted certificate indicates that the network function service consumer is successfully verified by a network repository network element. A method for verifying the first trusted certificate is similar to the method for verifying the trusted certificate in S703. For detailed content, refer to S703. Details are not described herein again.

The network function service provider may determine, by verifying the first trusted certificate of the network function service consumer, whether the network function service consumer is registered with the network repository network element and is successfully verified by the network repository network element.

An identity of a sender of the first attestation information, whether the attestation information is complete, whether the attestation information is tampered with, and the like may be determined by verifying the attestation information, to help reduce a threat that may be caused by the foregoing factors, and help improve security of a core network element.

S1904: The network function service provider verifies the access token.

The access token indicates that the network function service consumer is permitted to access a resource, data, or a service.

In some embodiments, the access token includes a first attestation result, and the first attestation result identifies that the network function service consumer is successfully verified through remote attestation.

In some embodiments, the access token includes a first attestation result, and the first attestation result identifies that the network function service consumer fails to be verified through remote attestation.

The access token of the network function service consumer is verified, to determine whether the network function service consumer has permission to access the service determined by using the access token, determine a type of the service that can be accessed by the network function service consumer, and determine information such as a time period in which the network function service consumer can access the service.

S1905: The network function service provider verifies the first attestation result of the network function service consumer.

In some embodiments, the first attestation result identifies that the network function service consumer fails to be verified through the remote attestation, and the network function service provider provides a limited service to the network function service consumer.

In some embodiments, the first attestation result identifies that the network function service consumer is successfully verified through the remote attestation, and the network function service provider provides, to the network function service consumer, the service requested by the network function service consumer.

The first attestation result of the network function service consumer is verified, to further verify, after the access token is verified, whether the remote attestation of the network function service consumer succeeds. This implements double verification on whether the remote attestation of the network function service consumer succeeds, and helps enhance protection of the network function service provider.

For an application scenario in which a delay requirement is low or a physical security level of the network function service consumer is high, S1905 may not be performed.

S1906: The network function service provider generates a second remote attestation parameter.

The network function service provider generates second attestation information based on the trusted platform of the network function service provider, where the second attestation information includes data such as a measurement value of software and/or hardware of the network function service provider, and the data is for determining whether the network function service provider is trusted.

An identity of a sender of the second attestation information, whether the attestation information is complete, whether the attestation information is tampered with, and the like may be determined by verifying the attestation information, to help reduce a threat that may be caused by the foregoing factors, and help improve the security of the core network element.

S1907: The network function service provider sends the service response message.

The service response message includes the second attestation information, and the second attestation information may be sent to the network function service consumer by sending the service response message, so that the network function service consumer verifies the network function service provider. The network function service consumer can obtain information about the data such as the measurement value of the software and/or the hardware of the network function service provider, to further determine, based on the attestation information, whether a running environment of the network function service provider is trusted.

S1908: The network function service consumer verifies the second attestation information.

The identity of the sender of the second attestation information, whether the attestation information is complete, whether the attestation information is tampered with, and the like may be determined by verifying the attestation information, to help reduce the threat that may be caused by the foregoing factors, and help improve security of the network function service consumer.

S1909: The network function service consumer establishes a service relationship with the network function service provider.

After determining that the running environment of the network function service provider is trusted, the network function service consumer establishes a connection to the network function service provider, and obtains the requested service from the network function service provider.

With reference to FIG. 3 to FIG. 20, the foregoing describes application of the communication method integrated with trustworthiness measurement provided in embodiments to different scenarios. Based on a same concept as the foregoing method embodiments, embodiments further provide a communication apparatus. The communication apparatus may have functions of the first network element, the network repository network element, the network function service consumer, and the network function service provider in the foregoing method embodiments, and may be configured to perform steps performed by the first network element, the network repository network element, the network function service consumer, and the network function service provider in the foregoing method embodiments.

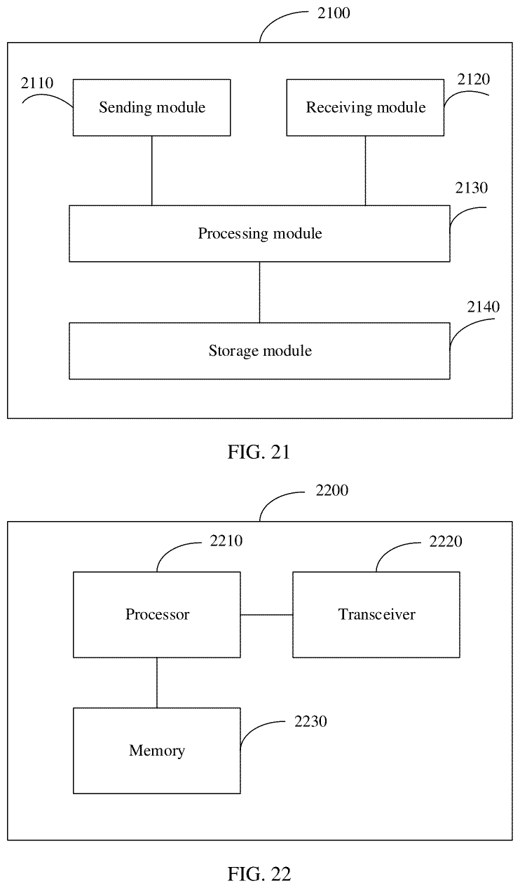

In a possible implementation, the communication apparatus 2100 shown in FIG. 21 may be used as the first network element in the foregoing method embodiments, and performs the steps performed by the first network element in the foregoing method embodiments.

As shown in FIG. 21, the communication apparatus 2100 may include a sending module 2110 and a receiving module 2120.

The sending module 2110 may be configured to support the communication apparatus 2100 in sending information, for example, performing sending actions performed by the first network element in S201, S501, S504, and S601 in FIG. 3, FIG. 6, and FIG. 7.

The receiving module 2120 may be configured to support the communication apparatus 2100 in receiving information, for example, performing receiving actions performed by the first network element in S202, S502, and S506 in FIG. 3, FIG. 6, and FIG. 7.

Optionally, the communication apparatus 2100 may further include a processing module 2130. The processing module 2130 is coupled to the sending module 2110 and the receiving module 2120, and may be configured to support the communication apparatus 2100 in performing processing actions in the foregoing method embodiments, for example, performing the processing actions performed by the first network element in S503, S507 and the like in FIG. 6.

In another possible implementation, the communication apparatus 2100 shown in FIG. 21 may be used as the network repository network element in the foregoing method embodiments, and performs the steps performed by the network repository network element in the foregoing method embodiments.

As shown in FIG. 21, the communication apparatus 2100 may include a sending module 2110 and a receiving module 2120.

The sending module 2110 may be configured to support the communication apparatus 2100 in sending information, for example, performing sending actions performed by the network repository network element in S202, S302, S502, S506, S603, S704, S710, S804, S904, S908, S1004, S1009, S1106, and S1206 in FIG. 3, FIG. 4, FIG. 6, FIG. 7, FIG. 8, FIG. 9, FIG. 10, FIG. 11, FIG. 12, and FIG. 13.

The receiving module 2120 may be configured to support the communication apparatus 2100 in receiving information, for example, performing receiving actions performed by the network repository network element in S201, S301, S501, S504, S601, S702, S706, S802, S902, S906, S1002, S1006, S1102, and S1202 in FIG. 3, FIG. 4, FIG. 6, FIG. 7, FIG. 8, FIG. 9, FIG. 10, FIG. 11, FIG. 12, and FIG. 13.

Optionally, the communication apparatus 2100 may further include a processing module 2130. The processing module 2130 is coupled to the sending module 2110 and the receiving module 2120, and may be configured to support the communication apparatus 2100 in performing processing actions in the foregoing method embodiments, for example, performing processing actions performed by the network repository network element such as S505, S602, S707, S708, S709, S803, S903, S907, S1003, S1007, S1008, S1103, S1104, S1105, S1203, S1204, and S1205 in FIG. 6, FIG. 7, FIG. 8, FIG. 9, FIG. 10, FIG. 11, FIG. 12, and FIG. 13.

In another possible implementation, the communication apparatus 2100 shown in FIG. 21 may be used as the network function service consumer in the foregoing method embodiments, and performs the steps performed by the network function service consumer in the foregoing method embodiments.

As shown in FIG. 21, the communication apparatus 2100 may include a sending module 2110 and a receiving module 2120.

The sending module 2110 may be configured to support the communication apparatus 2100 in sending information, for example, performing sending actions performed by the network function service consumer in S301, S401, S702, S706, S802, S902, S906, S1002, S1006, S1102, S1202, S1302, S1306, and S1313 in FIG. 4, FIG. 5, FIG. 8, FIG. 9, FIG. 10, FIG. 11, FIG. 12, FIG. 13, FIG. 14, FIG. 15, FIG. 16, FIG. 17, FIG. 18, FIG. 19, and FIG. 20.

The receiving module 2120 may be configured to support the communication apparatus 2100 in receiving information, for example, performing receiving actions performed by the network function service consumer in S302, S402, S704, S710, S804, S904, S908, S1004, S1009, S1106, S1206, S1304, S1311, S1315, S1404, S1504, S1508, S1604, S1610, S1704, S1711, S1804, S1811, S1815, and S1907 in FIG. 4, FIG. 5, FIG. 8, FIG. 9, FIG. 10, FIG. 11, FIG. 12, FIG. 13, FIG. 14, FIG. 15, FIG. 16, FIG. 17, FIG. 18, FIG. 19, and FIG. 20.

Optionally, the communication apparatus 2100 may further include a processing module 2130. The processing module 2130 is coupled to the sending module 2110 and the receiving module 2120, and may be configured to support the communication apparatus 2100 in performing processing actions in the foregoing method embodiments, for example, performing processing actions performed by the network function service consumer in S701, S705, S801, S901, S905, S1001, S1005, S1101, S1201, S1301, S1305, S1312, S1316, S1401, S1501, S1505, S1601, S1605, S1701, S1705, S1712, S1801, S1805, S1812, S1816, S1901, and S1908 in FIG. 8, FIG. 9, FIG. 10, FIG. 11, FIG. 12, FIG. 13, FIG. 14, FIG. 15, FIG. 16, FIG. 17, FIG. 18, FIG. 19, and FIG. 20.

In another possible implementation, the communication apparatus 2100 shown in FIG. 21 may be used as the network function service provider in the foregoing method embodiments, and performs the steps performed by the network function service provider in the foregoing method embodiments.

As shown in FIG. 21, the communication apparatus 2100 may include a sending module 2110 and a receiving module 2120.

The sending module 2110 may be configured to support the communication apparatus 2100 in sending information, for example, performing sending actions performed by the network function service provider in S401, S1304, S1311, S1315, S1404, S1504, S1508, S1604, S1610, S1704, S1711, S1804, S1811, S1815, and S1907 in FIG. 5, FIG. 14, FIG. 15, FIG. 16, FIG. 17, FIG. 18, FIG. 19, and FIG. 20.

The receiving module 2120 may be configured to support the communication apparatus 2100 in receiving information, for example, performing receiving actions performed by the network function service provider in S401, S1302, S1306, S1313, S1315, S1402, S1502, S1506, S1602, S1606, S1702, S1706, S1713, S1802, S1806, S1813, S1817, and S1902 in FIG. 5, FIG. 14, FIG. 15, FIG. 16, FIG. 17, FIG. 18, FIG. 19, and FIG. 20.

Optionally, the communication apparatus 2100 may further include a processing module 2130. The processing module 2130 is coupled to the sending module 2110 and the receiving module 2120, and may be configured to support the communication apparatus 2100 in performing processing actions in the foregoing method embodiments, for example, performing processing actions performed by the network function service provider such as S1303, S1307, S1308, S1309, S1310, S1314, S1403, S1503, S1507, S1603, S1607, S1608, S1609, S1703, S1707, S1708, S1709, S1710, S1803, S1807, S1808, S1809, S1810, S1903, S1904, S1905, and S1906 in FIG. 14, FIG. 15, FIG. 16, FIG. 17, FIG. 18, FIG. 19, and FIG. 20.

Optionally, the communication apparatus 2100 may further include a storage module 2140, configured to store program code and data of the communication apparatus 2100.

FIG. 22 is a block diagram of a communication device 2200 according to an embodiment. As shown in the figure, the communication device 2200 includes at least one processor 2210 and a transceiver 2220. The processor 2210 is coupled to a memory, and is configured to execute instructions stored in the memory, to control the transceiver 2220 to send a signal and/or receive a signal.

Optionally, the communication device 2200 further includes a memory 2230, configured to store instructions.

In some embodiments, the processor 2210 and the memory 2230 may be combined into one processing apparatus, and the processor 2210 is configured to execute program code stored in the memory 2230, to implement the foregoing functions. During specific implementation, the memory 2230 may alternatively be integrated into the processor 2210, or may be independent of the processor 2210.

In some embodiments, the transceiver 2220 may include a receiver (or referred to as a receive machine) and a transmitter (or referred to as a transmit machine).

The transceiver 2220 may further include one or more antennas. The transceiver 2220 may alternatively be a communication interface or an interface circuit.

When the communication device 2200 is a chip, the chip includes a transceiver unit and a processing unit. The transceiver unit may be an input/output circuit or a communication interface. The processing unit may be a processor, a microprocessor, or an integrated circuit integrated on the chip.

A person of ordinary skill in the art may be aware that, in combination with the examples described in embodiments, units and algorithm steps can be implemented by electronic hardware or a combination of computer software and electronic hardware. Whether the functions are performed by hardware or software depends on particular applications and design constraints of the solutions. A person skilled in the art may use different methods to implement the described functions for each particular application, but it should not be considered that the implementation goes beyond the scope of the embodiments.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided, it should be understood that the system, apparatus, and method may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, for example, may be located in one position, or may be distributed on a plurality of network units. Some or all of the units may be selected based on actual requirements to achieve the objectives of the solutions of embodiments.

In addition, functional units in embodiments may be integrated into one processing unit, each of the units may exist alone physically, or two or more units may be integrated into one unit.

When the functions are implemented in a form of a software functional unit and sold or used as an independent product, the functions may be stored in a non-transitory computer-readable storage medium. Based on such an understanding, the solutions of the embodiments essentially, the part contributing to a conventional technology, or a part of the solutions may be implemented in a form of a software product. The computer software product is stored in a storage medium, and includes several instructions for instructing a computer device (which may be a personal computer, a server, a network device, or the like) to perform all or a part of the steps of the methods described in embodiments. The foregoing storage medium includes any medium that can store program code, such as a USB flash drive, a removable hard disk drive, a read-only memory (ROM), a random access memory (RAM), a magnetic disk, or an optical disc.

The foregoing descriptions are merely implementations of the embodiments, but are not intended as limiting. Any variation or replacement readily figured out by a person skilled in the art shall fall within the scope of the embodiments.

1. A method applicable to a network function service consumer, the method comprising:
sending a service request for requesting to a service provided by a network function service provider; and
receiving a service response, wherein the service response indicates whether the requested service is available to the network function service consumer.

2. The method according to claim 1, wherein the service response is associated with:
(i) whether the request for the service is accepted, and
(ii) a result of trustworthiness verification of the network function service consumer.

3. The method according to claim 1, further comprising:
receiving second attestation identity information, wherein the second attestation identity information comprises requests to obtain one or more of:
second attestation information for verifying whether the network function service consumer is trusted: or
a third attestation result, wherein the third attestation result comprises an attestation result indicating that the network function service consumer has been attested to be trusted.

4. The method according to claim 1, wherein, after the service response indicates that the request for the service is accepted, the trustworthiness verification comprises one of:
(iii) verification of second attestation information or
(iv) verification of a third attestation result, the second attestation information is for verifying whether the network function service consumer is trusted, and the third attestation result comprises an attestation result indicating that the network function service consumer has been attested to be trusted.

5. The method according to claim 4, wherein the trustworthiness verification further comprises:
verifying a first attestation result; and the first attestation result comprises an attestation result indicating that the network function service consumer is attested by a network repository network element to be trusted.

6. The method according to claim 4, wherein the trustworthiness verification further comprises:
verifying a third trusted certificate, and the third trusted certificate is for verifying whether a trusted platform of the network function service consumer is trusted.

7. The method according to claim 1, wherein the service response indicates that the request for the service is rejected, and further indicates that a third trusted certificate fails to be verified, a first attestation result fails to be verified, second attestation information fails to be verified, or a third attestation result fails to be verified, the third trusted certificate is for verifying whether a trusted platform of the network function service consumer is trusted, the first attestation result comprises an attestation result indicating that the network function service consumer is attested by a network repository network element to be trusted, the second attestation information is for verifying whether the network function service consumer is trusted, and the third attestation result comprises an attestation result indicating that the network function service consumer has been attested to be trusted.

8. The method according to claim 1, wherein the service request further comprises the second attestation information and the second attestation information is associated with second challenge data.

9. The method according to claim 8, wherein the second challenge data comprises one or more of:
a timestamp,
a first random number provided by a trusted third party,
a second random number generated for verifying whether a trusted platform of the network function service consumer is trusted, and
a value of an agreed field.

10. A method applicable to a network function service provider, the method comprising:
receiving a service request, wherein the service request is used to request to a service provided by the network function service provider; and
sending a service response, wherein the service response indicates whether the request for the service is accepted, and further indicates a result of trustworthiness verification of a network function service consumer.

11. The method according to claim 10, further comprising:
sending second attestation identity information, wherein the second attestation identity information requests to obtain second attestation information or a third attestation result, the second attestation information is for verifying whether the network function service consumer is trusted, and the third attestation result comprises an attestation result indicating that the network function service consumer has been attested to be trusted.

12. The method according to claim 10, wherein the service response indicates that the request for the service is accepted, the trustworthiness verification comprises verification of second attestation information or verification of a third attestation result, the second attestation information is for verifying whether the network function service consumer is trusted, and the third attestation result comprises an attestation result indicating that the network function service consumer has been attested to be trusted.

13. The method according to claim 12, wherein the trustworthiness verification further comprises verification of a first attestation result, and the first attestation result comprises an attestation result indicating that the network function service consumer is attested by a network repository network element to be trusted.

14. The method according to claim 12, wherein the trustworthiness verification further comprises verification of a third trusted certificate, and the third trusted certificate is for verifying whether a trusted platform of the network function service consumer is trusted.

15. The method according to claim 10, wherein the service response indicates that the request for obtaining the service is accepted, the trustworthiness verification is verification of a first attestation result, and the first attestation result comprises an attestation result indicating that the network function service consumer is attested by a network repository network element to be trusted.

16. The method according to claim 10, wherein the service response indicates that the request for obtaining the service is rejected, and further indicates that a third trusted certificate fails to be verified, a first attestation result fails to be verified, second attestation information fails to be verified, or a third attestation result fails to be verified, the third trusted certificate is for verifying whether a trusted platform of the network function service consumer is trusted, the first attestation result comprises an attestation result indicating that the network function service consumer is attested by a network repository network element to be trusted, the second attestation information is for verifying whether the network function service consumer is trusted, and the third attestation result comprises an attestation result indicating that the network function service consumer has been attested to be trusted.

17. The method according to claim 10, wherein the service request further comprises the second attestation information, the second attestation information is generated based on second challenge data, and is for verifying whether the network function service consumer is trusted, the second challenge data is any one of a timestamp, a first random number provided by a trusted third party, a second random number generated for verifying whether a trusted platform of the network function service consumer is trusted, and a value of an agreed field.

18. An apparatus; comprising:
a processing circuit and an interface, wherein the processing circuit is configured to execute computer instructions to cause the interface to:
send a service request for requesting to a service provided by a network function service provider; and
receive a service response, wherein the service response indicates whether the requested service is available to the network function service consumer.

19. The apparatus according to claim 18, wherein the service response is associated with:
(i) whether the request for the service is accepted, and
(ii) a result of trustworthiness verification of the network function service consumer.

20. The apparatus according to claim 18, wherein the processing circuit is configured to execute computer instructions to cause the interface to:
receive second attestation identity information, wherein the second attestation identity information requests to obtain one or more of:
second attestation information for verifying whether the network function service consumer is trusted; or
a third attestation result, wherein the third attestation result comprises an attestation result indicating that the network function service consumer has been attested to be trusted.
